(19) United States
(12) Patent Application Publication
(10) Pub. No.: US 2026/0003029 A1
(43) Pub. Date: Jan. 1, 2026

(54) APPARATUS, SYSTEM, AND METHOD OF CONTROLLING A POLARIZATION OF A COMMUNICATED SIGNAL

(71) Applicant: MobilEye Vision Technologies Ltd., Jerusalem (IL)

(72) Inventors: Omer Asaf, Kfar Saba (IL); Naftali Landsberg, Kiryat Ono (IL); Danniel Nahmanny, Maor (IL); Meir Gordon, Holon (IL); Ophir Shabtay, Tsofit (IL)

(73) Assignee: MobilEye Vision Technologies Ltd., Jerusalem (IL)

(21) Appl. No.: 19/234,337

(22) Filed: Jun. 11, 2025

Related U.S. Application Data
(60) Provisional application No. 63/666,576, filed on Jul. 1, 2024.

(51) Int. Cl. G01S 7/02; H01Q 15/24

(52) U.S. Cl. CPC G01S 7/025; G01S 7/026; H01Q 15/24

(57) ABSTRACT

For example, polarization-control circuitry may be configured to control a polarization for a communicated signal according to a polarization setting. The polarization-control circuitry may include a first Radio Frequency (RF) path configured to communicate a first RF signal corresponding to the communicated signal via a first antenna port according to a first polarization; a second RF path configured to communicate a second RF signal corresponding to the communicated signal via a second antenna port according to a second polarization; phase-offsetting circuitry including at least one phase shifter in at least one path of the first RF path or the second RF path, the phase-offsetting circuitry configurable to apply a phase offset between the first RF signal in the first RF path and the second RF signal in the second RF path; and a controller to configure the phase-offsetting circuitry to apply the phase offset based on the polarization setting.

### CROSS REFERENCE

This Application claims the benefit of and priority from U.S. Provisional Patent Application No. 63/666,576 entitled “APPARATUS, SYSTEM, AND METHOD OF CONTROLLING A POLARIZATION OF A COMMUNICATED SIGNAL”, filed Jul. 1, 2024, the entire disclosure of which is incorporated herein by reference.

### BACKGROUND

Polarization is a property of a wave, which may define a geometrical orientation of oscillations of the wave.

The polarization of an Radio-Frequency (RF) wave, e.g., a communications signal, which is communicated via an antenna array, may be determined by one or more properties of antenna elements of the antenna array.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10 is a schematic illustration of a system, in accordance with some demonstrative aspects.

FIG. 11 is a schematic illustration of a dual-polarization antenna array, which may be implemented in accordance with some demonstrative aspects.

FIG. 12 is a schematic illustration of Rx circuitry including Rx polarization-control circuitry, in accordance with some demonstrative aspects.

FIG. 13 is a schematic illustration of Tx circuitry including Tx polarization-control circuitry, in accordance with some demonstrative aspects.

FIG. 14 is a schematic illustration of Rx circuitry including Rx polarization-control circuitry, in accordance with some demonstrative aspects.

FIG. 15 is a schematic illustration of Tx circuitry including Tx polarization-control circuitry, in accordance with some demonstrative aspects.

FIG. 16 is a schematic illustration of Rx circuitry including Rx polarization-control circuitry, in accordance with some demonstrative aspects.

FIG. 17 is a schematic illustration of Tx circuitry including Tx polarization-control circuitry, in accordance with some demonstrative aspects.

FIG. 18 is a schematic illustration of Rx circuitry including Rx polarization-control circuitry, in accordance with some demonstrative aspects.

FIG. 19 is a schematic illustration of Tx circuitry including Tx polarization-control circuitry, in accordance with some demonstrative aspects.

FIG. 20 is a schematic flow chart illustration of a method of controlling a polarization of a communicated signal, in accordance with some demonstrative aspects.

FIG. 21 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, aspect, or design described herein as “exemplary” or “demonstrative” is not necessarily to be construed as preferred or advantageous over other aspects, aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHz, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure, and/or arrangement of one or more antenna elements, components, units, assemblies, and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a MIMO (Multiple-Input Multiple-Output) array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

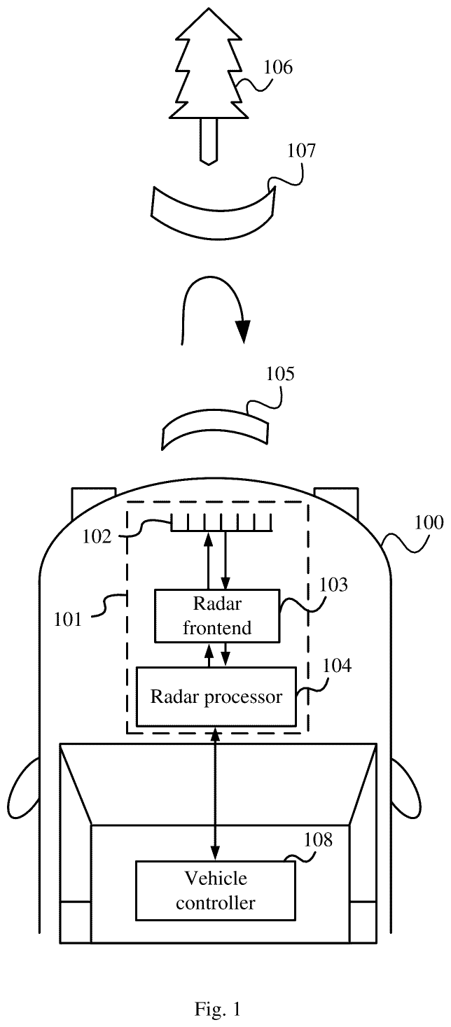

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, an assisted vehicle system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar aspects, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include road users, such as other vehicles, pedestrians; road objects and markings, such as traffic signs, traffic lights, lane markings, road markings, road elements, e.g., a pavement-road meeting, a road edge, a road profile, road roughness (or smoothness); general objects, such as a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below.

In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer or a circulator, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems, and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment, and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identity a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

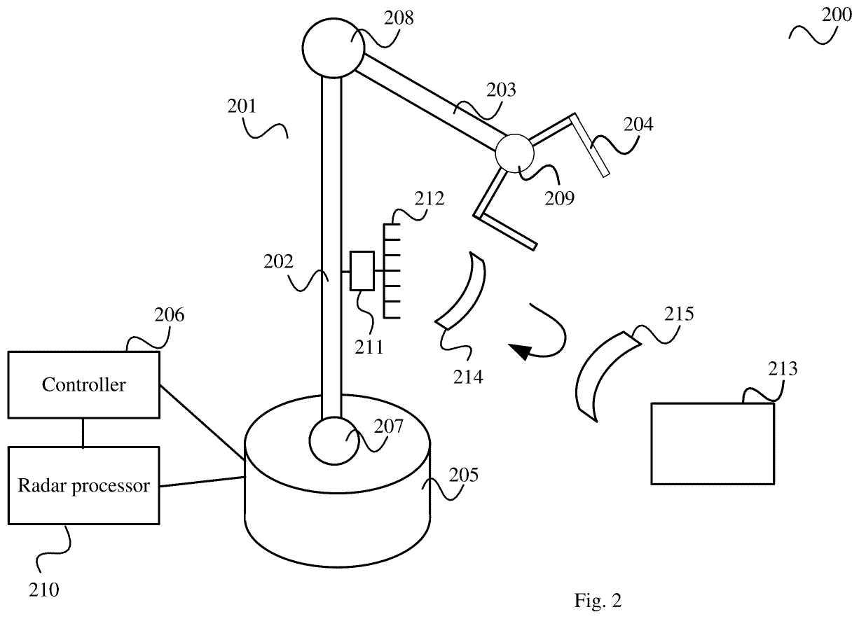

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e. actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

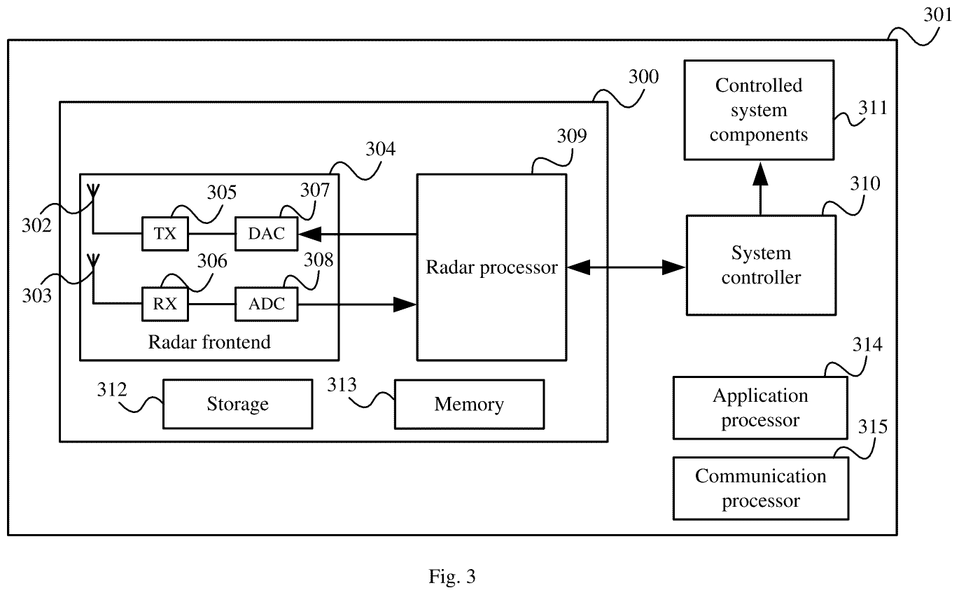

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may configured to perform one or more operations and/or functionalities of, the devices or systems described above with reference to FIG. 1 and/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, the radar information from radar processor 309 may be processed, e.g., by system controller 310 and/or any other element of system 301, for example, in combination with information from one or more other of information sources, for example, LiDAR information from a LiDAR processor, vision information from a vision-based processor, or the like.

In some demonstrative aspects, an environmental model of an environment of system 301 may be determined, e.g., by system controller 310 and/or any other element of system 301, for example, based on the radar information from radar processor 309, and/or the information from one or more other of information sources.

In some demonstrative aspects, a driving policy system, e.g., which may be implemented by system controller 310 and/or any other element of system 301, may process the environmental model, for example, to decide on one or more actions, which may be taken.

In some demonstrative aspects, system controller 310 may be configured to control one or more controlled system components 311 of the system 301, e.g., a motor, a brake, steering, and the like, e.g., by one or more corresponding actuators, for example, based on the one or more action decisions.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a continuous wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated Continuous Wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

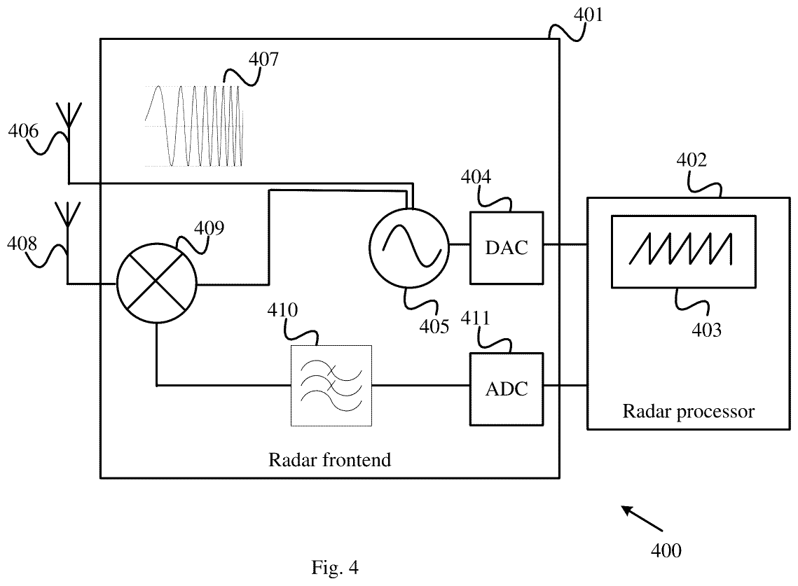

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

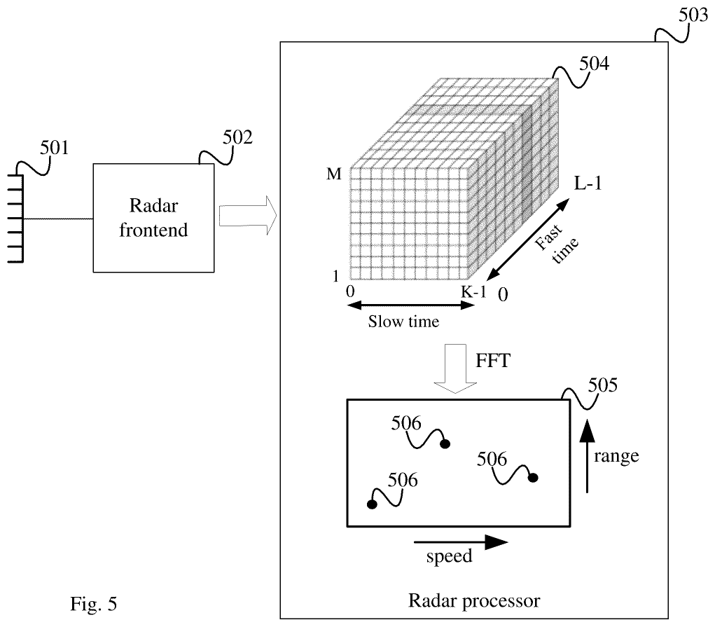

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time”-direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time”-direction of the data cube 504.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

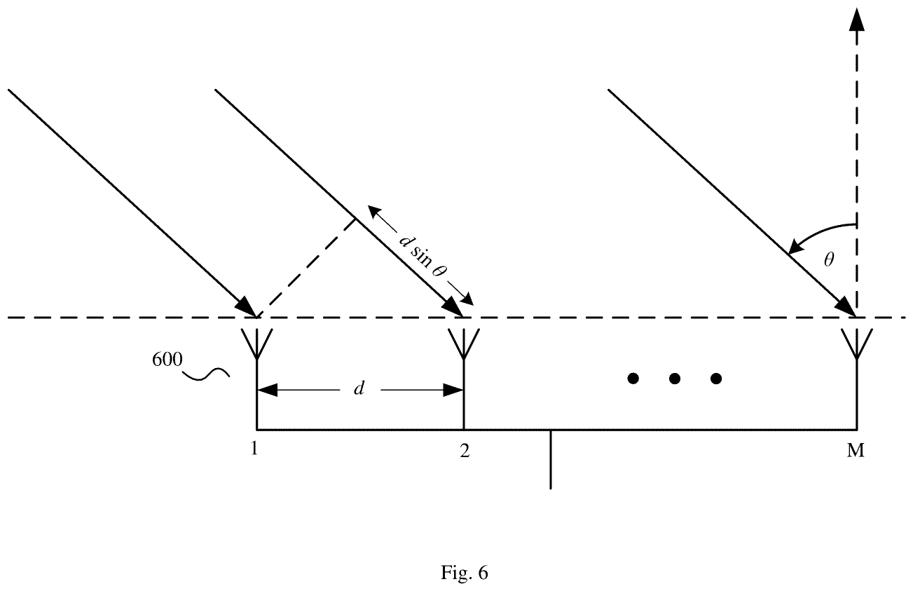

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array.

In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Ap, between two antennas of the receive antenna array 600 may be determined, e.g., as follows:

$$Δφ = \frac{2 π}{λ} \cdot d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

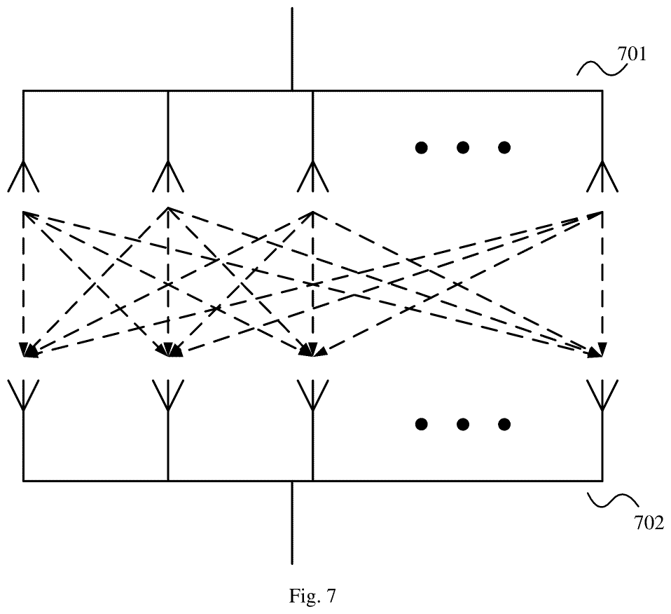

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

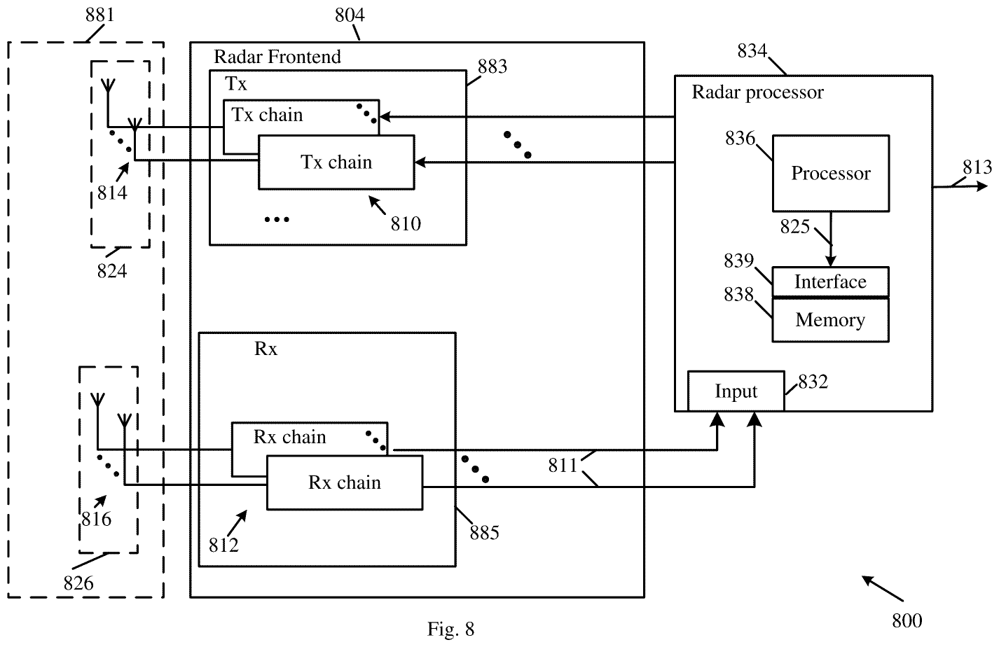

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design.

In other aspects, any other form, shape, and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, processor 836 may interface with memory 838, for example, via a memory interface 839.

In some demonstrative aspects, processor 836 may be configured to access memory 838, e.g., to write data to memory 838 and/or to read data from memory 838, for example, via memory interface 839.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data. In one example, the range information and/or Doppler information may be determined based on a Cross-Correlation (XCORR) operation, which may be applied to the radar Rx data. Any other additional or alternative operation, algorithm, and/or procedure may be utilized to generate the range information and/or Doppler information.

In some demonstrative aspects, memory 838 may be configured to store AoA information, which may be generated by processor 836, for example, based on the radar Rx data, the range information and/or Doppler information. In one example, the AoA information may be determined based on an AoA estimation algorithm. Any other additional or alternative operation, algorithm, and/or procedure may be utilized to generate the AoA information.

In some demonstrative aspects, radar processor 834 may be configured to generate the radar information 813 including one or more of range information, Doppler information, and/or AoA information.

In some demonstrative aspects, the radar information 813 may include Point Cloud 1 (PC1) information, for example, including raw point cloud estimations, e.g., Range, Radial Velocity, Azimuth, and/or Elevation.

In some demonstrative aspects, the radar information 813 may include additional information, which may be, for example, based on the raw point cloud estimations, and/or may be related to the raw point cloud estimations.

In some demonstrative aspects, the radar information 813 may include metadata information corresponding to the raw point cloud estimations.

In some demonstrative aspects, the radar information 813 may include, for example, information relating to a reliability level of the raw point cloud estimations, information relating to one or more parameters, conditions and/or criteria implemented in determining the raw point cloud estimations, and/or any other suitable additional or alternative information.

For example, the radar information 813 may include Log Likelihood Ratio (LLR) information corresponding to the raw point cloud estimations, Radar Cross Section (RCS) estimation information, Signal to Noise Ratio (SNR) estimation information, and/or any other suitable additional or alternative information.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like. In one example, the PC2 information may be based on one or more temporal filtering techniques, which may be applied to the PC1 information, for example, for temporal filtering of multiple frames and/or multiple PC1 instances.

In some demonstrative aspects, the radar information 813 may include target tracking information corresponding to a plurality of targets in an environment of the radar device 800, e.g., as described below.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

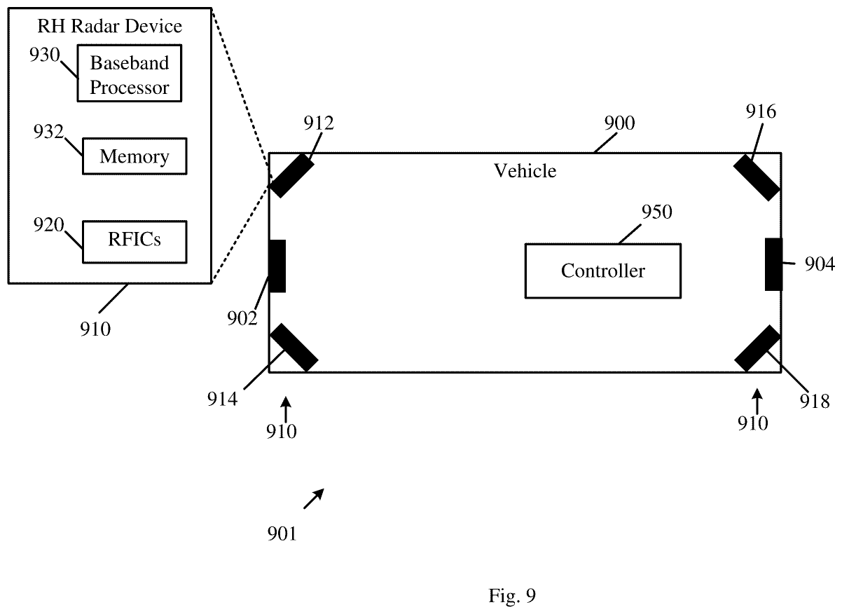

Reference is made to FIG. 9, which schematically illustrates a radar system 901 including a plurality of Radio Head (RH) radar devices (also referred to as RHs) 910 implemented in a vehicle 900, in accordance with some demonstrative aspects.

In some demonstrative aspects, as shown in FIG. 9, the plurality of RH radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of RH radar devices 910 may include, for example, six RH radar devices 910, e.g., as described below.

In some demonstrative aspects, the plurality of RH radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of RH radar devices 910 may include any other number of RH radar devices 910, e.g., less than six radar devices or more than six radar devices.

In other aspects, the plurality of RH radar devices 910 may be positioned at any other locations and/or according to any other arrangement, which may support radar sensing at any other field of view around vehicle 900, e.g., 360-degrees radar sensing or radar sensing of any other field of view.

In some demonstrative aspects, as shown in FIG. 9, vehicle 900 may include a first RH radar device 902, e.g., a front RH, at a front-side of vehicle 900.

In some demonstrative aspects, as shown in FIG. 9, vehicle 900 may include a second RH radar device 904, e.g., a back RH, at a back-side of vehicle 900.

In some demonstrative aspects, as shown in FIG. 9, vehicle 900 may include one or more of RH radar devices at one or more respective corners of vehicle 900. For example, vehicle 900 may include a first corner RH radar device 912 at a first corner of vehicle 900, a second corner RH radar device 914 at a second corner of vehicle 900, a third corner RH radar device 916 at a third corner of vehicle 900, and/or a fourth corner RH radar device 918 at a fourth corner of vehicle 900.

In some demonstrative aspects, vehicle 900 may include one, some, or all, of the plurality of RH radar devices 910 shown in FIG. 9. For example, vehicle 900 may include the front RH radar device 902 and/or back RH radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the RH radar devices 910.

In some demonstrative aspects, at least part of the functionality of radar system controller 950 may be implemented by a dedicated controller, e.g., a dedicated system controller or central controller, which may be separate from the RH radar devices 910, and may be configured to control some or all of the RH radar devices 910.

In some demonstrative aspects, at least part of the functionality of radar system controller 950 may be implemented as part of at least one RH radar device 910.

In some demonstrative aspects, at least part of the functionality of radar system controller 950 may be implemented by a radar processor of an RH radar device 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, an RH radar device 910 of the plurality of RH radar devices 910, may include a baseband processor 930 (also referred to as a “Baseband Processing Unit (BPU)”), which may be configured to control communication of radar signals by the RH radar device 910, and/or to process radar signals communicated by the RH radar device 910. For example, baseband processor 930 may include one or more elements of radar processor 834 (FIG. 8), and/or may perform one or more operations and/or functionalities of radar processor 834 (FIG. 8).

In other aspects, an RH radar device 910 of the plurality of RH radar devices 910 may exclude one or more, e.g., some or all, functionalities of baseband processor 930. For example, controller 950 may be configured to perform one or more, e.g., some or all, functionalities of the baseband processor 930 for the RH.

In one example, controller 950 may be configured to perform baseband processing for all RH radar devices 910, and all RH radio devices 910 may be implemented without baseband processors 930.

In another example, controller 950 may be configured to perform baseband processing for one or more first RH radar devices 910, and the one or more first RH radio devices 910 may be implemented without baseband processors 930; and/or one or more second RH radar devices 910 may be implemented with one or more functionalities, e.g., some or all functionalities, of baseband processors 930.

In another example, one or more, e.g., some or all, RH radar devices 910 may be implemented with one or more functionalities, e.g., partial functionalities or full functionalities, of baseband processors 930.

In some demonstrative aspects, baseband processor 930 may include one or more components and/or elements configured for digital processing of radar signals communicated by the RH radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, RH radar device 910 may include a memory 932, which may be configured to store data processed by, and/or to be processed by, baseband processor 930. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In other aspects, an RH radar device 910 of the plurality of RH radar devices 910 may exclude memory 932. For example, the RH radar device 910 may be configured to provide radar data to controller 950, e.g., in the form of raw radar data.

In some demonstrative aspects, as shown in FIG. 9, RH radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, radar performance of a radar device may be affected by one or more properties of an antenna array of the radar device. For example, a polarization and/or one or more other properties of the antenna array may be based, for example, on one or more properties of one or more array elements of the antenna array and/or on a size of the antenna array.

For example, there may be one or more technical problems, disadvantages, and/or inefficiencies in an implementation of a phased array antenna having polarization settings, which are fixed and/or identical across all antenna elements of the phased array antenna. For example, such a phased array antenna may have a fixed polarization, which may not be changed and/or adapted. For example, a polarization of a phased array antenna, where the polarization of each element is fixed, may depend on the observation angle or the steering angle of the phased array antenna. For example, this may be the result of a polarization variation over a radiation pattern of each element of the phased array antenna.

In some demonstrative aspects, a radar device, e.g., as described above with reference to FIGS. 1-9, may be configured to implement one or more operations and/or functionalities of a polarization control mechanism, which may be configured to provide a technical solution to support controlling a polarization of a communicated signal, which is communicated by the radar device, e.g., as described below.

In some demonstrative aspects, a radar device, e.g., as described above with reference to FIGS. 1-9, may be configured to implement a configurable polarization architecture, which may be configured to provide a technical solution to support the controlling of the polarization of the communicated signal, e.g., as described below.

In some demonstrative aspects, a radar device, e.g., as described above with reference to FIGS. 1-9, may be configured to implement a configurable polarization architecture, for example, for a phased array antenna implemented by the radar device. For example, the configurable polarization architecture may be configured to provide a technical solution to support controlling of a polarization of a communicated signal, for example, via the phased array antenna, e.g., as described below.

In some demonstrative aspects, a radar device, e.g., as described above with reference to FIGS. 1-9, may be configured to implement the configurable polarization architecture, for example, as part of, or in the form of, a dual-amplifier RF frontend, e.g., as described below.

In some demonstrative aspects, a radar device, e.g., as described above with reference to FIGS. 1-9, may be configured to implement one or more operations and/or functionalities of a polarization control mechanism, which may be configured to provide a technical solution to support controlling, e.g., dynamically controlling, a polarization of an antenna array, e.g., as described below.

In some demonstrative aspects, a radar device, e.g., as described above with reference to FIGS. 1-9, may be configured to implement one or more operations and/or functionalities of a polarization control mechanism, which may be configured to provide a technical solution to support controlling polarization of an antenna array, for example, according to a plurality of polarization settings, e.g., as described below.

In some demonstrative aspects, the polarization control mechanism may be configured to support controlling polarization of the antenna array, for example, according to a plurality of polarization settings, which may include one or more linear polarization settings, for example, a vertical polarization, a horizontal polarization, and/or any other suitable type and/or orientation of liner polarization, e.g., as described below.

In some demonstrative aspects, the polarization control mechanism may be configured to support controlling polarization of the antenna array, for example, according to a plurality of polarization settings, which may include one or more circular polarization settings, for example, a left-hand circular polarization, a right-hand circular polarization, and/or any other suitable type and/or orientation of circular polarization, e.g., as described below.

In some demonstrative aspects, the polarization control mechanism may be configured to support controlling polarization of the antenna array, for example, according to a plurality of polarization settings, which may include one or more elliptical polarization settings, e.g., as described below.

In other aspects, the polarization control mechanism may be configured to support controlling polarization of the antenna array according to any other additional or alternative type of polarization setting.

In some demonstrative aspects, the polarization control mechanism may be configured to support controlling polarization of the antenna array, for example, according to substantially any possible polarization setting, for example, within a predefined range of polarizations, e.g., as described below.

In some demonstrative aspects, the polarization control mechanism may be configured to control the polarization of the antenna array according to substantially any linear orientation within a predefined range of linear polarizations, e.g., as described below.

In some demonstrative aspects, the polarization control mechanism may be configured to control the polarization of the antenna array according to substantially any circular polarization within a predefined range of circular polarizations, e.g., as described below.

In some demonstrative aspects, the polarization control mechanism may be configured to control the polarization of the antenna array according to substantially any elliptical polarization within a predefined range of elliptical polarizations, e.g., as described below.

In some demonstrative aspects, a radar device, e.g., as described above with reference to FIGS. 1-9, may be configured to implement one or more operations and/or functionalities of a polarization control mechanism, for example, to provide a technical solution to support dynamic control of the polarization of the antenna array, for example, per one or more radar communication and/or processing settings and/or requirements, e.g., as described below.

For example, antenna arrays of a radar device may be configured for example, such that a receive (received) polarization of an Rx antenna array for receiving Rx radar signals may be generally aligned with a transmit (transmitted) polarization of a Tx antenna array for transmitting Tx radar signals.

In some demonstrative aspects, for example, in some use cases or scenarios, the polarization control mechanism may be implemented, for example, to align the receive polarization of the Rx antenna array, for example, based on a cross-polarization of the Tx antenna array, for example, to provide a technical solution to support extraction of additional information.

In some demonstrative aspects, a radar device, e.g., as described above with reference to FIGS. 1-9, may be configured to implement one or more operations and/or functionalities of a polarization control mechanism, which may be configured to provide a technical solution to support correction of a cross polarization, e.g., to improve a cross polarization rejection ratio, for example, per observation angle in a field of view of an antenna array of the radar device, e.g., as described below.

In some demonstrative aspects, a radar device, e.g., as described above with reference to FIGS. 1-9, may be configured to implement a configurable polarization architecture, for example, to provide a technical solution to support controlling the polarization of an antenna array, for example, according to substantially any possible polarization within a predefined range of polarizations, e.g., as described below.

In some demonstrative aspects, the configurable polarization architecture may be based on a front end, e.g., an improved front end, which may be configured to include a dual amplifier front-end, e.g., as described below.

In one example, the configurable polarization architecture may include a dual Power Amplifier (PA) architecture, for example, when implemented as part of a transmitter front end, e.g., as described below.

In another example, the configurable polarization architecture may include a dual Low Noise Amplifier (LNA) architecture, for example, when implemented as part of a receiver front end, e.g., as described below.

In some demonstrative aspects, the configurable polarization architecture may include two paths, which may be configured to communicate signals via two antenna ports having different polarizations, e.g., as described below.

For example, a first path of the configurable polarization architecture may include a first amplifier, which may be configured to amplify signals communicated via a first antenna port corresponding to a first polarization, e.g., as described below.

For example, a second path of the configurable polarization architecture may include a second amplifier, which may be configured to amplify signals communicated via a second antenna port corresponding to a second polarization, which may be different from the first polarization, e.g., as described below.

In some demonstrative aspects, the first and second paths of the configurable polarization architecture may be configured to be connected to two respective antenna ports of a dual-polarization antenna element of an antenna array, for example, as part of a phased array antenna, e.g., as described below.

In some demonstrative aspects, the first and second paths of the configurable polarization architecture may be configured to be connected to antenna ports of two respective antenna elements of an antenna array, e.g., as described below.

In some demonstrative aspects, an RF chain, e.g., each RF chain, of an RF frontend may include two amplifiers, which may be connected to two respective antenna ports, which correspond to different polarizations, e.g., as described below.

In some demonstrative aspects, an Rx RF chain, e.g., each Rx RF chain, of an Rx RF frontend may include two LNAs, which may be connected to two respective antenna ports, which correspond to different polarizations, e.g., as described below.

For example, signals amplified by the two LNAs may be combined, for example, by a power combiner, e.g., as described below.

In some demonstrative aspects, a Tx RF chain, e.g., each Tx RF chain, of a Tx RF frontend may include two PAs, which may be connected to two respective antenna ports, which correspond to different polarizations, e.g., as described below.

For example, a Tx signal for the Tx RF chain may be split, e.g., by a power splitter, into two Tx signals to be provided to the PAs, e.g., as described below.

In some demonstrative aspects, the configurable polarization architecture may include a phase shifter and/or a phase rotator, which may be configured to apply a phase offset between the first and second paths, e.g., as described below.

In some demonstrative aspects, the configurable polarization architecture may be implemented to provide a technical solution to support setting of a polarization of a dual-port antenna of an antenna array, e.g., independently of other antenna elements in the antenna array, for example, by connecting the first and second paths to first and second antenna ports of the dual-port antenna.

In some demonstrative aspects, the configurable polarization architecture may be configured to provide a technical solution to support an “all-polarization receiver/transmitter” and/or an “all polarization phased array radar”, for example, which may be configured according to a selected polarization for an antenna element and/or for the entire array, for example, on-the-fly, e.g., as described below.

In some demonstrative aspects, the configurable polarization architecture may be configured to provide a technical solution to support different polarizations for a transmitter and a receiver. For example, in some use cases, it may be beneficial to receive with a receive polarization, which may be substantially a cross polarization of a transmit polarization, for example, in order to provide technical solution to extract additional information of a target, e.g., compared to a scenario where a receive polarization is aligned with a transmit polarization.

In one example, a scattering pattern of a target in a first polarization may be different, e.g., in many cases, from a scattering pattern of the same target in a second polarization, e.g., a polarization which is orthogonal to the first polarization.

In another example, a scattering pattern of an environment, e.g., the ground, may be attenuated, for example, by using a particular polarization.

In some demonstrative aspects, the configurable polarization architecture may be implemented to provide a technical solution to support configurable polarization for the transmitter and/or the receiver, for example, to support transmission of a signal in a first polarization and reception of a reflected signal, which is based on the transmitted signal, in a second polarization, which is different from, e.g., orthogonal to, the first polarization.

In some demonstrative aspects, the configurable polarization architecture may be configured to provide a technical solution to support setting a polarization of an antenna element, e.g., each antenna element, of an antenna array, e.g., independently from other antenna elements. Accordingly, the configurable polarization architecture may be implemented to provide a technical solution to support auto-correction of co-polarization performance and/or cross-polarization performance of a phased array antenna, for example, per a desired observation angle and/or per a steering angle. For example, the configurable polarization architecture may be implemented to provide a technical solution to support auto-correction of co-polarization performance and/or cross-polarization performance of the phased array antenna, for example, for substantially any polarization, e.g., a linear polarization, a circular polarization, and/or an elliptical polarization, e.g., as described below.

For example, a polarization of a phased array antenna, where the polarization of each element is fixed, may depend on the observation angle or the steering angle of the phased array antenna. For example, this may be the result of a polarization variation over a radiation pattern of each element of the phased array antenna.

In some demonstrative aspects, a radar device, e.g., as described above with reference to FIGS. 1-9, may be configured to provide a technical solution to support a low cost and/or a flexible architecture, for example, for a multimodal system, to control a polarization of a communicated signal, e.g., as described below.

In some demonstrative aspects, the configurable polarization architecture may be configured to provide a technical solution to support setting a polarization for an antenna element to substantially any polarization of all polarizations within a predefined range of polarizations, e.g., as described below.

In some demonstrative aspects, the configurable polarization architecture may be configured to provide a technical solution to support switching, e.g., substantially immediate switching, the antenna element between substantially any of the supported polarizations, e.g., as described below.

In some demonstrative aspects, the configurable polarization architecture may be configured to provide a technical solution to support configurable polarization of antennas of a radar system, e.g., Rx antennas and/or Tx antennas, for example, to improve a sensitivity of the radar system, for example, in response to Radar Cross Section (RCS) polarization changes, clutter, and/or multipath suppression.

In some demonstrative aspects, the configurable polarization architecture may be configured to provide a technical solution to support improved overall performance of a radar perception, for example, by performing measurements using different polarizations, and by filtering and enhancing output information, e.g., point cloud information, e.g., by a tracker.

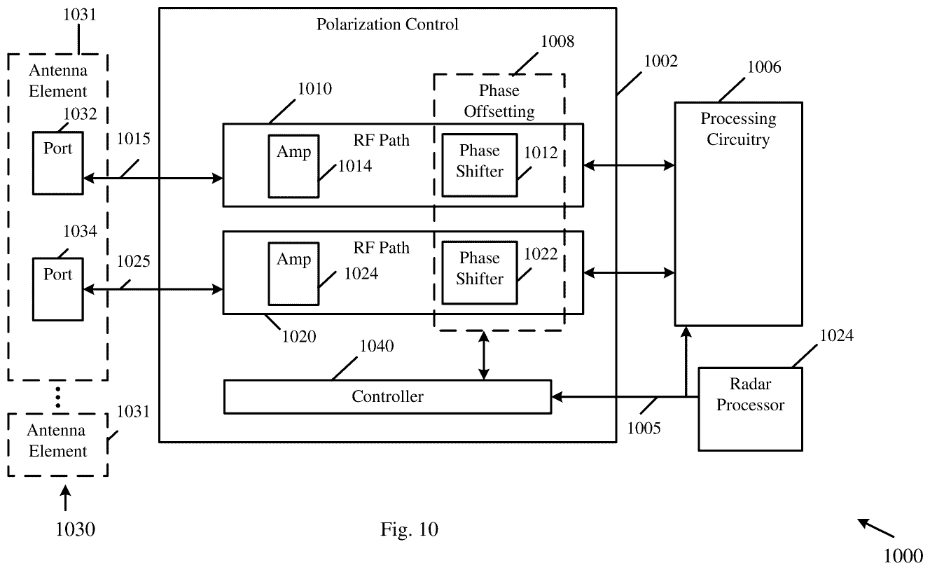

Reference is made to FIG. 10, which schematically illustrates a system 1000, in accordance with some demonstrative aspects.

In some demonstrative aspects, one or more components of system 1000 may be implemented as part of a radar device. For example, radar device 800 (FIG. 8) may include one or more element of system 1000, and/or may perform one or more operations and/or functionalities of system 1000.

In some demonstrative aspects, system 1000 may be implemented as part of any other suitable device and/or system.

For example, in some demonstrative aspects, system 1000 may be implemented as part of a device, for example, a mobile device, a computing device, and/or a wireless communication device, for example, to communicate RF wireless communication signals.

For example, in some demonstrative aspects, system 1000 may be implemented to communicate the RF wireless communication signals over millimeter wave (mmWave) frequencies and/or any other suitable frequencies.

In some demonstrative aspects, system 1000 may include polarization-control circuitry 1002, which may be configured to control a polarization for a communicated signal, for example, according to a polarization setting 1005, e.g., as described below.

In some demonstrative aspects, polarization-control circuitry 1002 may include a first RF path 1010, e.g., as described below.

In some demonstrative aspects, first RF path 1010 may be configured to communicate a first RF signal 1015 corresponding to the communicated signal, for example, via a first antenna port 1032, for example, according to a first polarization, e.g., as described below.

In some demonstrative aspects, polarization-control circuitry 1002 may include a second RF path 1020, e.g., as described below.

In some demonstrative aspects, second RF path 1020 may be configured to communicate a second RF signal 1025 corresponding to the communicated signal, for example, via a second antenna port 1034, for example, according to a second polarization, e.g., as described below.

In some demonstrative aspects, polarization-control circuitry 1002 may include phase-offsetting circuitry 1008, which may be configurable to apply a phase offset between the first RF signal 1015 in the first RF path 1010 and the second RF signal 1025 in the second RF path 1020, e.g., as described below.

In some demonstrative aspects, phase-offsetting circuitry 1008 may include at least one phase shifter in at least one path of the first RF path 1010 or the second RF path 1020, e.g., as described below.

In some demonstrative aspects, phase-offsetting circuitry 1008 may include a first-path phase shifter 1012 in the first RF path 1010, e.g., as described below.

In some demonstrative aspects, phase-offsetting circuitry 1008 may include a second-path phase shifter 1022 in the second RF path 1020, e.g., as described below.

In some demonstrative aspects, phase-offsetting circuitry 1008 may include first-path phase shifter 1012 in the first RF path 1010 and second-path phase shifter 1022 in the second RF path 1020, e.g., as described below.

In other aspects, phase-offsetting circuitry 1008 may include first-path phase shifter 1012 in the first RF path 1010, e.g., while second-path phase shifter 1022 may be excluded from the second RF path 1020.

In other aspects, phase-offsetting circuitry 1008 may include second-path phase shifter 1022 in the second RF path 1020, e.g., while first-path phase shifter 1012 may be excluded from the first RF path 1010.

In some demonstrative aspects, polarization-control circuitry 1002 may include a controller 1040, which may be configured to configure the phase-offsetting circuitry 1008, e.g., as described below.

In some demonstrative aspects, controller 1040 may be configured to configure the phase-offsetting circuitry 1008, for example, to apply the phase offset, for example, based on the polarization setting 1005, e.g., as described below.

In some demonstrative aspects, the first polarization may be orthogonal to the second polarization, e.g., as described below.

In other aspects, the first polarization and the second polarization may be any other, e.g., non-orthogonal, polarizations.

In some demonstrative aspects, the first polarization may include a Vertical (V) polarization, e.g., as described below.

In some demonstrative aspects, the second polarization may be a Horizontal (H) polarization, e.g., as described below.

For example, a horizontal polarization and/or the vertical polarization may be defined with respect to the ground. In one example, a horizontal polarization and/or a vertical polarization may be defined with respect to a road, e.g., in case of a polarized antenna implemented by a vehicle. For example, the horizontal polarization may be in a plane substantially parallel to the horizon, e.g., parallel to the road; and/or the vertical polarization may be in a plane substantially perpendicular to the horizon, e.g., perpendicular to the road.

In other aspects, the first polarization and/or the second polarization may include any other polarizations.

In some demonstrative aspects, the first RF path 1010 may be configured to communicate the first RF signal 1015 via a first antenna port 1032 of a dual-polarization antenna element 1031, e.g., as described below.

In some demonstrative aspects, the second RF path 1020 may be configured to communicate the second RF signal 1025 via a second antenna port 1034 of the dual-polarization antenna element 1031, e.g., as described below.

In some demonstrative aspects, system 1000 may include an antenna array 1030 including a plurality of dual-polarization antenna elements 1031, e.g., as described below.

In some demonstrative aspects, as shown in FIG. 10, the antenna ports 1032 and 1034 may belong to a same antenna element 1031, e.g., as described above.

In other aspects, the antenna ports 1032 and 1034 may belong to separate antenna elements 1031, e.g., as described below.

In some demonstrative aspects, the first RF path 1010 may be configured to communicate the first RF signal 1015 via a first antenna port 1032 of a first antenna element 1031, e.g., as described below.

In some demonstrative aspects, the second RF path 1020 may be configured to communicate the second RF signal 1025 via a second antenna port 1034 of a second antenna element 1031, e.g., as described below.

In some demonstrative aspects, antenna array 1030 may include a plurality of antenna elements 1031 including the first and second antenna elements 1031, e.g., as described below.

In one example, the first and second antenna elements may be on the same aperture, or on separate apertures.

In some demonstrative aspects, the polarization-control circuitry 1002 may be configured to control the polarization for the communicated signal, for example, according to a plurality of polarization settings 1005, e.g., as described below.

In some demonstrative aspects, system 1000 may include a processor 1024, e.g., a radar processor 1024, which may be configured to determine the polarization setting 1005, e.g., as described below. For example, radar processor 834 (FIG. 8) may include one or more elements of a radar processor 1024, and/or may perform one or more operations and/or functionalities of a radar processor 1024.

In some demonstrative aspects, processor 1042 may be configured to determine the polarization setting 1005, for example, based on a steering angle of the antenna array 1030, which may communicate the communicated signal, e.g., as described below.

In other aspects, the processor 1042 may be configured to determine the polarization setting 1005, for example, based on any other additional and/or alternative parameter, criterion, condition, and/or method.

In some demonstrative aspects, the polarization-control circuitry 1002 may be configured to control the polarization for the communicated signal, for example, according to substantially any polarization setting 1005 within a predefined range of polarizations, e.g., as described below.

In some demonstrative aspects, the polarization-control circuitry 1002 may be configured to control the polarization for the communicated signal, for example, according to a linear polarization setting, e.g., as described below.

In some demonstrative aspects, the polarization-control circuitry 1002 may be configured to control the polarization for the communicated signal, for example, according to substantially any linear polarization setting, for example, within a predefined range of linear polarizations, e.g., as described below.

In some demonstrative aspects, the polarization-control circuitry 1002 may be configured to control the polarization for the communicated signal, for example, according to a selected linear polarization setting from a plurality of linear polarization settings, e.g., as described below.

In some demonstrative aspects, the plurality of linear polarization settings may include a Vertical (V) polarization setting, a Horizontal (H) polarization setting, and a 45 degrees linear polarization setting, e.g., as described below.

In other aspects, the plurality of linear polarization settings may include any other additional and/or alternative linear polarization setting.

In some demonstrative aspects, the polarization-control circuitry 1002 may be configured to control the polarization for the communicated signal, for example, according to a Circular Polarization (CP) setting, e.g., as described below.

In some demonstrative aspects, the polarization-control circuitry 1002 may be configured to control the polarization for the communicated signal, for example, according to substantially any CP setting, for example, within a predefined range of circular polarizations, e.g., as described below.

In some demonstrative aspects, the polarization-control circuitry 1002 may be configured to control the polarization for the communicated signal, for example, according to a selected CP setting from a plurality of circular polarization settings, e.g., as described below.

In some demonstrative aspects, the plurality of circular polarization setting may include a Clockwise (CW) CP setting, and a Counter CW (CCW) CP setting, e.g., as described below.

In other aspects, the plurality of circular polarization setting may include any other additional and/or alternative CP setting.

In some demonstrative aspects, the polarization-control circuitry 1002 may be configured to control the polarization for the communicated signal, for example, according to an elliptical polarization, e.g., as described below.

In one example, the elliptical polarization may include a CW elliptical polarization. In another example, the elliptical polarization may include a CCW elliptical polarization.

In some demonstrative aspects, the polarization-control circuitry 1002 may be configured to control the polarization for the communicated signal, for example, according to substantially any elliptical polarization within a predefined range of elliptical polarizations, e.g., as described below.

In some demonstrative aspects, the polarization-control circuitry 1002 may be configured to control the polarization for the communicated signal, for example, according to a selected elliptical polarization setting from a plurality of elliptical polarization settings, e.g., as described below.

In some demonstrative aspects, the phase-offsetting circuitry 1008 may be configurable to apply substantially any phase offset within a predefined range of phase offsets, for example, corresponding to the range of polarization settings, e.g., as described below.

In some demonstrative aspects, controller 1040 may be configured to configure the phase-offsetting circuitry 1008 to apply a first phase offset, for example, based on a first polarization setting 1005, e.g., as described below.

In some demonstrative aspects, controller 1040 may be configured to configure the phase-offsetting circuitry 1008 to apply a second phase offset, for example, based on a second polarization setting 1005, e.g., as described below.

In some demonstrative aspects, the first polarization setting 1005 may be different from the second polarization setting 1005, e.g., as described below.

In some demonstrative aspects, the first phase offset may be different from the second phase offset, e.g., as described below.

In some demonstrative aspects, the polarization for the communicated signal may be based, for example, on the first polarization, the second polarization, and the phase offset, e.g., as described below.

In some demonstrative aspects, the polarization for the communicated signal may be based, for example, on a combination of the first polarization and the second polarization, for example, according to the phase offset, e.g., as described below.

In some demonstrative aspects, first-path phase shifter 1012 may be configurable to apply a first-path phase shift to the first RF signal 1015 in the first RF path 1010, e.g., as described below.

In some demonstrative aspects, second-path phase shifter 1022 may be configurable to apply a second-path phase shift to the second RF signal 1025 in the second RF path 1020, e.g., as described below.

In some demonstrative aspects, controller 1040 may be configured to configure the first-path phase shifter 1012 to apply the first-path phase shift and the second-path phase shifter 1012 to apply the second-path phase shift, for example, based on the polarization setting 1005, e.g., as described below.

In some demonstrative aspects, at least one phase of the first phase shifter 1012 or the second phase shifter 1022 may include a switchable phase shifter, e.g., as described below.

In some demonstrative aspects, the switchable phase shifter may be switchable between a plurality of predefined phase-shifter settings corresponding to a plurality of predefined phase shifts, e.g., as described below.

In some demonstrative aspects, the switchable phase shifter may include an Inductor (L) Capacitor (C) (LC) circuit, e.g., as described below.

In other aspects, the switchable phase shifter may include any other additional or alternative type of circuit.

In other aspects, the first phase shifter 1012 and/or the second phase shifter 1022 may include any other type of phase shifter.

In some demonstrative aspects, controller 1040 may be configured to set the switchable phase shifter to a selected phase-shifter setting from the plurality of predefined phase-shifter settings, for example, based on the polarization setting 1005, e.g., as described below.

In some demonstrative aspects, the plurality of predefined phase-shift settings may include three predefined phase-shift settings, e.g., as described below.

In other aspects, the plurality of predefined phase-shift settings may include any other count of predefined phase-shift settings.

In some demonstrative aspects, the switchable phase shifter may include a plurality of phase-shifter paths corresponding to the plurality of predefined phase-shifter settings, e.g., as described below.

In some demonstrative aspects, controller 1040 may be configured to switch the switchable phase shifter to a selected phase-shifter path of the plurality of phase-shifter paths, for example, based on the predefined phase-shift setting, e.g., as described below.

In some demonstrative aspects, at least one phase shifter of the first phase shifter 1012 or the second phase shifter 1022 may include a variable phase shifter, e.g., as described below.

In some demonstrative aspects, the polarization control circuitry 1002 may implement at least one variable phase shifter, for example, to provide a technical solution to support a plurality of circular polarization settings, e.g., any circular polarization setting within a predefined range of circular polarizations, and/or to support a plurality of elliptical polarization settings, e.g., any elliptical polarization within a predefined range of elliptical polarizations, e.g., as described below.

In some demonstrative aspects, at least one phase shifter of the first phase shifter 1012 or the second phase shifter 1022 may include a phase rotator, e.g., as described below.

In some demonstrative aspects, the polarization control circuitry 1002 may implement at least one phase rotator, for example, to provide a technical solution to support a plurality of circular polarization settings, e.g., any circular polarization setting within a predefined range of circular polarizations, and/or to support a plurality of elliptical polarization settings, e.g., any elliptical polarization within a predefined range of elliptical polarizations, e.g., as described below.

In some demonstrative aspects, at least one RF path of the first RF path 1010 or the second RF path 1020 may include an amplifier, e.g., as described below.

In some demonstrative aspects, the first RF path 1010 may include an amplifier 1014 to amplify the first RF signal 1015, e.g., as described below.

In some demonstrative aspects, amplifier 1014 may implemented be between antenna port 1032 and phase shifter 1012, e.g., as described below.

In some demonstrative aspects, the second RF path 1020 may include an amplifier 1024 to amplify the second RF signal 1025, e.g., as described below.

In some demonstrative aspects, amplifier 1024 may be implemented between antenna port 1034 and phase shifter 1022, e.g., as described below.

In some demonstrative aspects, the polarization control circuitry 1002 may utilize the amplifier 1014 and/or the amplifier 1024, for example, to provide a technical solution to support a plurality of linear polarization settings, e.g., any linear polarization setting within a predefined range of linear polarizations, e.g., ±90° or any other range of polarizations, e.g., as described below.

For example, the polarization control circuitry 1002 may be configured to control the amplifier 1014 to set a scaling of 0.5 to amplify the first RF signal 1015, e.g., for a vertical polarization antenna, and to control the amplifier 1024 to set a scaling of 0.866 to amplify the second RF signal 1025, e.g., for a horizontal polarization antenna, for example, in order to set a linear polarization of 30°, for example, along a line crossing the horizon for the communicated signal.

In one example, polarization control circuitry 1002 may include amplifier 1014 and/or amplifier 1024, for example, to provide a technical solution to address a loss to the RF circuitry, which may be introduced by one or more elements of system 1000, e.g., phase-offsetting circuitry 1008, and or a power splitter or combiner.

In some demonstrative aspects, at least one amplifier of the first amplifier 1014 or the second amplifier 1024 may include an adjustable amplifier, e.g., as described below.

In some demonstrative aspects, the first amplifier 1014 may include an adjustable amplifier, e.g., as described below.

In some demonstrative aspects, the second amplifier 1024 may include an adjustable amplifier, e.g., as described below.

In one example, the adjustable amplifier may include a controlled amplifier or a controlled attenuator, which may be implemented by a weighting circuit, e.g., as described below.

In some demonstrative aspects, controller 1040 may be configured to configure the adjustable amplifier, e.g., the first amplifier 1014 and/or the second amplifier 1024, for example, according to a gain difference to be applied between the first RF signal 1015 in the first RF path 1010 and the second RF signal 1025 in the second RF path 1020, e.g., as described below.

In some demonstrative aspects, the gain difference may be based, for example, on the polarization setting 1005, e.g., as described below.

In some demonstrative aspects, system 1000 may include processing circuitry 1006, which may be connected to the first RF path 1010 and to the second RF path 1020, e.g., as described below.

In some demonstrative aspects, processing circuitry 1006 may be configured to process the communicated signal, for example, based on the polarization setting 1005, e.g., as described below.

In some demonstrative aspects, processing circuitry 1006 may include RF processing circuitry, e.g., as described below.

In some demonstrative aspects, processing circuitry 1006 may include a baseband processor, e.g., as described below.

In other aspects, processing circuitry 1006 may include any other type of processing circuitry.

In some demonstrative aspects, the communicated signal may include a Tx signal, e.g., as described below.

In some demonstrative aspects, the first RF signal 1015 and the second RF signal 1025 may be based, for example, on a splitting of the Tx signal, e.g., as described below.

For example, the first RF signal 1015 may include a first Tx signal, and the second RF signal 1025 may include a second Tx signal, which may be based on the Tx signal.

In some demonstrative aspects, the first RF path 1010 may include a first PA to amplify the first RF signal 1015 to be transmitted via the first antenna port 1032, for example, when the communicated signal includes the Tx signal, e.g., as described below.

In some demonstrative aspects, the second RF path 1020 may include a second PA to amplify the second RF signal 1025 to be transmitted via the second antenna port 1034, for example, in an implementation where the communicated signal includes the Tx signal, e.g., as described below.

For example, first amplifier 1014 may include the first PA, and/or second amplifier 1024 may include the second PA, for example, in an implementation where the communicated signal includes the Tx signal, e.g., as described below.

In some demonstrative aspects, the communicated signal may include a Receive (Rx) signal, e.g., as described below.

In some demonstrative aspects, the Rx signal may be based, for example, on a combination of the first RF signal 1015 and the second RF signal 1025, e.g., as described below.

For example, the first RF signal 1015 may include a first Rx signal, and the second RF signal 1025 may include a second Rx signal.

In some demonstrative aspects, the first RF path 1010 may include a first LNA to amplify the first RF signal 1015 received via the first antenna port 1032, for example, in an implementation where the communicated signal includes the Rx signal, e.g., as described below.

In some demonstrative aspects, the second RF path 1020 may include a second LNA to amplify the second RF signal 1025 received via the second antenna port 1034, for example, in an implementation where the communicated signal includes the Rx signal, e.g., as described below.

For example, first amplifier 1014 may include the first LNA, and/or second amplifier 1024 may include the second LNA, for example, in an implementation where the communicated signal includes the Rx signal, e.g., as described below.

In some demonstrative aspects, as shown in FIG. 10, system 1000 may be implemented according to an architecture, which may include connection of the polarization control circuitry 1002 to a dual-polarization antenna element 1031, for example, to support dynamic changing of a polarization of the dual-polarization antenna element 1031, e.g., as described above.

In some demonstrative aspects, system 1000 may be implemented according to an architecture, which may include connection of the first RF path 1010 of the polarization control circuitry 1002 to a port of a first antenna element and connection of the second RF path 1020 of the polarization control circuitry 1002 to a port of a second antenna element. For example, this architecture may be configured to provide a technical solution to support dynamic changing of a polarization of two antenna elements. For example, the two antenna elements may have different linear polarizations. For example, the two antenna elements may not be at the same location, and/or may not be concentric.

In some demonstrative aspects, system 1000 may be configured to provide a technical solution to support substantially any linear polarization and/or circular polarization, for example, to any observation angle of antenna array 1030. For example, system 1000 may be configured to provide a technical solution to support correcting any linear polarization and/or circular polarization, for example, similar to correcting co-polarization or the cross-polarization, e.g., as described above.

In some demonstrative aspects, system 1000 may be configured to provide a technical solution to support substantially any polarization within a predefined range of polarizations, for example, to enhance performance of a system implementing communication of RF signals, and/or to cover a wider field of view, for example, even without substantially any performance and/or SNR degradation, e.g., while maintaining full flexibility.

In some demonstrative aspects, system 1000 may be configured to provide a technical solution to support substantially any polarization within a predefined range of polarizations for communication of RF signals utilizing a phase array antenna. For example, system 1000 may be implemented to support RF communications performed by radar applications, localization applications, satellite applications, communication applications, drone applications, and/or the like.

In some demonstrative aspects, system 1000 may be configured to provide a technical solution to support systems, which utilized a dual polarization and/or a circular polarization. For example, system 1000 may be implemented to support RF communications performed by satellite communication systems, e.g., with fixed ground stations, mobile stations, and/or customer premises equipment, satellite navigation systems, retransmission links, and/or the like.

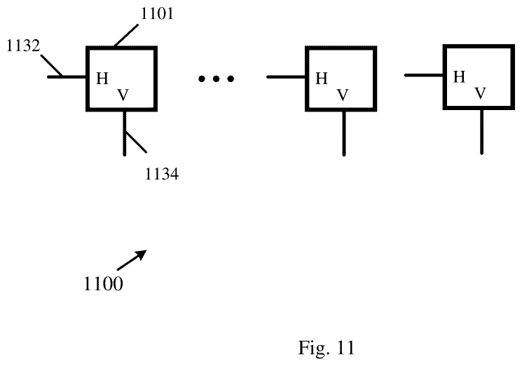

Reference is made to FIG. 11, which schematically illustrates a dual-polarization antenna array 1100, which may be implemented in accordance with some demonstrative aspects.

For example, as shown in FIG. 11, dual-polarization antenna array 1100 may include a plurality of dual-polarization antenna elements 1101.

For example, as shown in FIG. 11, a dual-polarization antenna element 1101 may include a first antenna port 1132 and a second antenna port 1134.

For example, as shown in FIG. 11, first antenna port 1132 may correspond to a first polarization, e.g., a horizontal polarization.

For example, as shown in FIG. 11, second antenna port 1134 may correspond to a second polarization, e.g., a vertical polarization.

For example, as shown in FIG. 11, first antenna port 1132 may be perpendicular to second antenna port 1134.

For example, as shown in FIG. 11, the vertical polarization may be perpendicular to the horizontal polarization.

In some demonstrative aspects, polarization-control circuitry 1002 (FIG. 10) may be configured to communicate the first RF signal 1015 (FIG. 10) via the first antenna port 1132, for example, according to the horizontal polarization.

In some demonstrative aspects, polarization-control circuitry 1002 (FIG. 10) may be configured to communicate the second RF signal 1025 (FIG. 10) via the second antenna port 1134, for example, according to the vertical polarization.

In some demonstrative aspects, dual-polarization antenna element 1101 may support a left-hand circular polarization or a right-hand circular polarization, for example, by applying a phase offset, e.g., an optional ±90° phase offset, between the first RF signal 1015 (FIG. 10) and the second RF signal 1025 (FIG. 10).

In some demonstrative aspects, a weighting circuit may be connected to the first port 1132 and the second port 1134, for example, to support substantially any linear polarization or circular polarization, e.g., as described below.

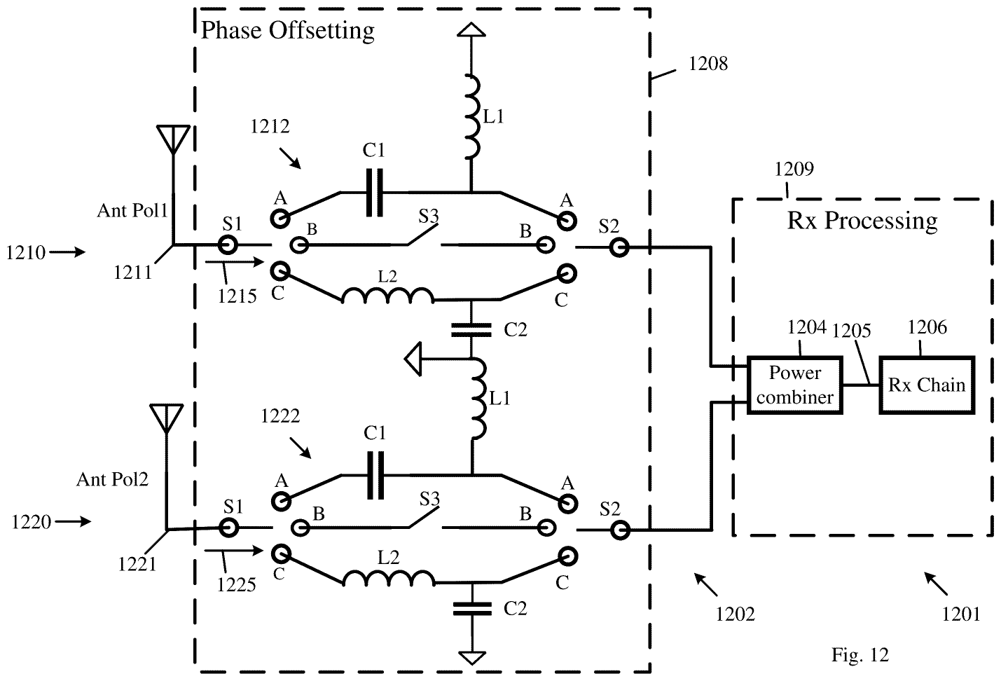

Reference is made to FIG. 12, which schematically illustrates Rx circuitry 1201 including Rx polarization-control circuitry 1202, in accordance with some demonstrative aspects.

For example, polarization control circuitry 1002 (FIG. 10) may include one or more elements of Rx polarization-control circuitry 1202, and/or may perform one or more operations and/or functionalities of Rx polarization-control circuitry 1202.

In some demonstrative aspects, Rx polarization-control circuitry 1202 may be configured to control a polarization for an Rx signal 1205, for example, based on an Rx polarization setting.

In some demonstrative aspects, as shown in FIG. 12, Rx polarization-control circuitry 1202 may include a first Rx path 1210, which may configured to receive a first Rx signal 1215 via a first antenna port 1211, for example, according to a first polarization, e.g., a horizontal polarization.

In some demonstrative aspects, as shown in FIG. 12, Rx polarization-control circuitry 1202 may include a second Rx path 1220, which may configured to receive a second Rx signal 1225 via a second antenna port 1221, for example, according to a second polarization, e.g., a vertical polarization.

In some demonstrative aspects, as shown in FIG. 12, the Rx signal 1205 may be based, for example, on a combination of the first Rx signal 1215 and the second Rx signal 1225.

In some demonstrative aspects, as shown in FIG. 12, Rx polarization-control circuitry 1202 may include phase-offsetting circuitry 1208, which may be configurable to apply a phase offset between the first Rx signal 1215 in the first Rx path 1210 and the second Rx signal 1225 in the second Rx path 1220.

In some demonstrative aspects, a controller, e.g., controller 1040 (FIG. 10) may be configured to configure phase-offsetting circuitry 1208 to apply the phase offset between the first Rx signal 1215 in the first Rx path 1210 and the second Rx signal 1225 in the second Rx path 1220, for example, based on an Rx polarization setting.

In some demonstrative aspects, as shown in FIG. 12, phase-offsetting circuitry 1208 may include a first-path phase shifter 1212, which may be configurable to apply a first-path phase shift to the first Rx signal 1215 in the first Rx path 1210.

In some demonstrative aspects, as shown in FIG. 12, phase-offsetting circuitry 1208 may include a second-path phase shifter 1222, which may be configurable to apply a second-path phase shift to the second Rx signal 1225 in the second Rx path 1220.

In some demonstrative aspects, the first-path phase shift, which is applied to the first Rx signal 1215 in the first Rx path 1210, and the second-path phase shift, which is applied to the second Rx signal 1225 in the second Rx path 1220, may be configured, e.g., based on the Rx polarization setting, to result in the phase offset between the first Rx signal 1215 in the first Rx path 1210 and the second Rx signal 1225 in the second Rx path 1220.

In some demonstrative aspects, as shown in FIG. 12, Rx circuitry 1201 may include Rx processing circuitry 1209, which may be configured to process the Rx signal 1205, for example, based on the Rx polarization setting.

In some demonstrative aspects, as shown in FIG. 12, Rx circuitry 1201 may include a power combiner 1204, which may be configured to combine the first Rx signal 1215 and the second Rx signal 1225 into the Rx signal 1205.

In some demonstrative aspects, as shown in FIG. 12, Rx circuitry 1201 may include Rx chain circuitry 1206, which may be configured to process the Rx signal 1235, for example, based on the Rx polarization setting.

In some demonstrative aspects, the phase offset between the first Rx signal 1215 in the first Rx path 1210 and the second Rx signal 1225 in the second Rx path 1220 may be configured, for example, such that a combination of the first Rx signal 1215 and the second Rx signal 1225, e.g., by power combiner 1204, may result in a polarization of the Rx signal 1205, which may be according to the Rx polarization setting.

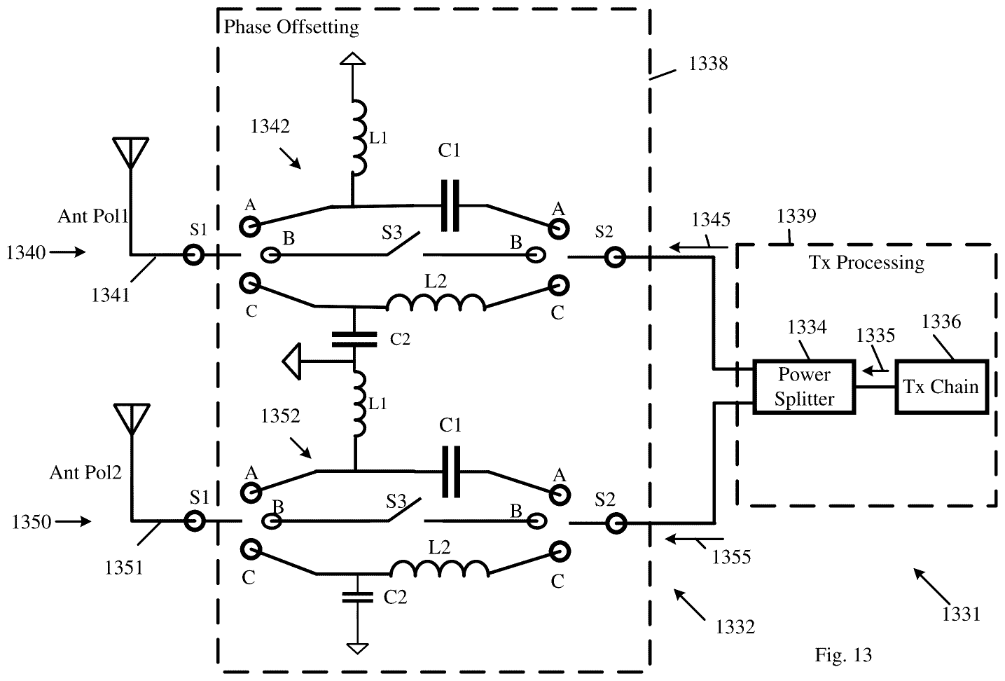

Reference is made to FIG. 13, which schematically illustrates Tx circuitry 1231 including Tx polarization-control circuitry 1332, in accordance with some demonstrative aspects. For example, polarization control circuitry 1002 (FIG. 10) may include one or more elements of Tx polarization-control circuitry 1332, and/or may perform one or more operations and/or functionalities of Tx polarization-control circuitry 1332.

In some demonstrative aspects, Tx polarization-control circuitry 1332 may be configured to control a polarization for a Tx signal 1335, for example, based on a Tx polarization setting.

In some demonstrative aspects, as shown in FIG. 13, Tx polarization-control circuitry 1332 may include a first Tx path 1340, which may be configured to transmit a first Tx signal 1345 via a first antenna port 1341, for example, according to a first polarization, e.g., a horizontal polarization.

In some demonstrative aspects, as shown in FIG. 13, Tx polarization-control circuitry 1332 may include a second Tx path 1350, which may be configured to transmit a second Tx signal 1355 via a second antenna port 1351, for example, according to a second polarization, e.g., a vertical polarization.

In some demonstrative aspects, as shown in FIG. 13, the first Tx signal 1345 and the second Tx signal 1355 may be based, for example, on splitting of the Tx signal 1335.

In some demonstrative aspects, as shown in FIG. 13, Tx polarization-control circuitry 1332 may include a phase-offsetting circuitry 1338, which may be configurable to apply a phase offset between the first Tx signal 1345 in the first Tx path 1340 and the second Tx signal 1355 in the second Tx path 1350.

In some demonstrative aspects, a controller, e.g., controller 1040 (FIG. 10), may be configured to configure phase-offsetting circuitry 1338 to apply the phase offset between the first Tx signal 1345 in the first Tx path 1340 and the second Tx signal 1355 in the second Tx path 1350, for example, based on the Tx polarization setting.

In some demonstrative aspects, as shown in FIG. 13, phase-offsetting circuitry 1338 may include a first-path phase shifter 1342, which may be configurable to apply a first-path phase shift to the first Tx signal 1345 in the first Tx path 1350.

In some demonstrative aspects, as shown in FIG. 13, phase-offsetting circuitry 1338 may include a second-path phase shifter 1352, which may be configurable to apply a second-path phase shift to the second Tx signal 1355 in the second Tx path 1350.

In some demonstrative aspects, the first-path phase shift, which is applied to the first Tx signal 1345 in the first Tx path 1340, and the second-path phase shift, which is applied to the second Tx signal 1355 in the second Tx path 1350, may be configured, e.g., based on the Tx polarization setting, to result in the phase offset between the first Tx signal 1345 in the first Tx path 1340 and the second Tx signal 1355 in the second Tx path 1350.

In some demonstrative aspects, as shown in FIG. 13, Tx circuitry 1331 may include Tx processing circuitry 1339, which may be configured to process the Tx signal 1335, for example, based on the Tx polarization setting.

In some demonstrative aspects, as shown in FIG. 13, Tx processing circuitry 1339 may include a power splitter 1334, which may be configured to split the Tx signal 1335 into the first Tx signal 1345 and the second Tx signal 1355.

In some demonstrative aspects, as shown in FIG. 13, Tx circuitry 1331 may include Tx chain circuitry 1336, which may be configured to process the Tx signal 1335, for example, based on the Tx polarization setting.

In some demonstrative aspects, as shown in FIG. 13, the phase offset between the first Tx signal 1345 in the first Tx path 1340 and the second Tx signal 1355 in the second Tx path 1350 may be configured, for example, such that a combined Tx signal, which is based on the first Tx signal 1355 and the second Tx signal 1355, may have a polarization, which is according to the Tx polarization setting. For example, the combined Tx signal may include a combination of the first Tx signal 1355, which is processed by the first-path phase shifter 1342 and transmitted via the first RF path first antenna port 1341, and the second Tx signal 1355, which is processed by the second-path phase shifter 1352 and transmitted via the second antenna port 1351.

In some demonstrative aspects, as shown in FIG. 12 and FIG. 13, Rx polarization-control circuitry 1202 (FIG. 12) and/or Tx polarization-control circuitry 1332, may implemented using one or more, e.g., some or all, same or substantially similar polarization-control circuitry components.

In some demonstrative aspects, a phase shifter of the phase-offsetting circuitry of FIG. 12 and/or FIG. 13, e.g., first-path phase shifter 1212 (FIG. 12), second-path phase shifter 1222 (FIG. 12), first-path phase shifter 1342, and/or second-path phase shifter 1352, may include an LC circuit, for example, including an inductor, denoted L1, and a capacitor, denoted C1, and/or an inductor, denoted L2, and a capacitor, denoted C2.

In some demonstrative aspects, a phase shifter of the phase-offsetting circuitry of FIG. 12 and/or FIG. 13, e.g., first-path phase shifter 1212 (FIG. 12), second-path phase shifter 1222 (FIG. 12), first-path phase shifter 1342, and/or second-path phase shifter 1352, may be switchable between a plurality of predefined phase-shifter settings corresponding to a plurality of predefined phase shifts.

In some demonstrative aspects, as shown in FIG. 12 and FIG. 13, the plurality of predefined phase-shift settings may include three predefined phase-shift settings, denoted A, B, C, which may correspond to three predefined phase shifts.

In some demonstrative aspects, a phase shifter of the phase-offsetting circuitry of FIG. 12 and/or FIG. 13, e.g., first-path phase shifter 1212 (FIG. 12), second-path phase shifter 1222 (FIG. 12), first-path phase shifter 1342, and/or second-path phase shifter 1352, may include a plurality of phase-shifter paths corresponding to the plurality of predefined phase-shifter settings, e.g., as described below.

In some demonstrative aspects, as shown in FIG. 12 and FIG. 13, the plurality of phase-shifter paths may include three paths corresponding to the three predefined phase-shift settings A, B, and C.

In some demonstrative aspects, a phase shifter of the phase-offsetting circuitry of FIG. 12 and/or FIG. 13, e.g., first-path phase shifter 1212 (FIG. 12), second-path phase shifter 1222 (FIG. 12), first-path phase shifter 1342, and/or second-path phase shifter 1352, may include a first switch, denoted S1, and a second switch, denoted S2, which may be configured to switch between the three paths corresponding to the three predefined phase-shift settings A, B, and C.

In some demonstrative aspects, as shown in FIG. 12 and FIG. 13, a first phase shift path corresponding to the predefined phase-shift settings A may be configured to apply a “+45°” phase shift to an RF signal communicated via the first phase shift path A.

In some demonstrative aspects, as shown in FIG. 12 and FIG. 13, a second phase shift path corresponding to the predefined phase-shift settings B may be configured to apply a “0°” phase shift to an RF signal communicated via the second phase shift path B.

In some demonstrative aspects, as shown in FIG. 12 and FIG. 13, the second phase shift path corresponding to the predefined phase-shift settings B may be configured to apply the “0°” phase shift to the RF signal communicated via the second phase shift path, for example, when a third switch, denoted S3, is at a closed (ON) state.

In some demonstrative aspects, as shown in FIG. 12 and FIG. 13, the third switch S3 may disconnect the second phase shift path, for example, when the third switch S3 is at an open (OFF) state.

In some demonstrative aspects, as shown in FIG. 12 and FIG. 13, a third phase shift path corresponding to the predefined phase-shift settings C may be configured to apply a “−45°” phase shift to an RF signal communicated via the third phase shift path C.

In some demonstrative aspects, as shown in FIG. 12 and FIG. 13, the first phase shift path and the third phase shift path may be implemented by an LC network.

In some demonstrative aspects, as shown in FIG. 12 and FIG. 13, the second phase shift path may be implemented by a transmission line, e.g., a short line, with a switch, e.g., the switch S3.

In some demonstrative aspects, the first phase shift path and/or the third phase shift path may be implemented using a Resistor-Inductor (RL) circuit and/or a Resistor-Capacitor (RC) circuit.

In other aspects, the first phase shift path and/or the third phase shift path may be implemented using any other suitable circuit.

In one example, the Resistor-Capacitor (RC) circuit may be implemented, for example, to save silicon area.

In other aspects, the second phase shift path may be implemented using any other type of transmission line, e.g., to implement a 90° phase offset between the first path and the second path, for example, if physical area is not a major concern.

In some demonstrative aspects, a controller, e.g., controller 1040 (FIG. 10), may be configured to switch the first switch SI and the second switch S2 between the plurality of phase-shifter paths corresponding to the three predefined phase-shift settings A, B, and C.

In some demonstrative aspects, the controller, e.g., controller 1040 (FIG. 10) may be configured to switch the switch S3 between the on state and the off state.

In some demonstrative aspects, the controller, e.g., controller 1040 (FIG. 10) may be configured to configure phase-offsetting circuitry 1208 (FIG. 12) to apply the phase offset between RF path 1210 and RF path 1220, for example, by configuring switches S1, S2 and S3 of phase shifter 1212 (FIG. 12), and switches S1, S2 and S3 of phase shifter 1222 (FIG. 12).

In some demonstrative aspects, the controller, e.g., controller 1040 (FIG. 10) may be configured to configure phase-offsetting circuitry 1338 to apply the phase offset between the first Tx signal 1345 in the first Tx path 1340 and the second Tx signal 1355 in the second Tx path 1350, for example, by configuring switches S1, S2 and S3 of phase shifter 1342, and switches S1, S2 and S3 of phase shifter 1352.

Referring back to FIG. 10, in some demonstrative aspects, controller 1040 may be configured to configure phase-offsetting circuitry 1008, e.g., phase-offsetting circuitry 1208 (FIG. 12) and/or phase-offsetting circuitry 1338 (FIG. 13), according to a selected polarization from a plurality of polarizations settings, for example, based on a switch setting from a plurality of switch settings. For example, the plurality of switch settings may correspond to the plurality of polarizations settings.

In some demonstrative aspects, a switch setting may include setting of first-path switches, denoted S1a, S2a and S3a of a first-path phase shifter, denoted Ant Pol1, of the phase-offsetting circuitry, and second-path switches, denoted S1b, S2band S3b, of a second-path phase shifter, denoted Ant Pol2, of the phase-offsetting circuitry.

For example, a switch setting corresponding to phase-offsetting circuitry 1208 (FIG. 12) may include setting of switches S1, S2 and S3 of phase shifter 1212 (FIG. 12), and switches S1, S2 and S3 of phase shifter 1222 (FIG. 12).

For example, a switch setting corresponding to phase-offsetting circuitry 1338 (FIG. 13) may include setting of switches S1, S2 and S3 of phase shifter 1342 (FIG. 13), and switches S1, S2 and S3 of phase shifter 1352 (FIG. 13).

In one example, the plurality of switch settings corresponding to the plurality of polarizations settings may be defined, e.g., as follows:

TABLE 1

| Ant Pol1 | Ant Pol1 | Ant Pol2 | Ant Pol2 | |
|---|---|---|---|---|
| S1a&S2a | S3a | S1b&Sb2 | S3b | Tx/Rx Pol |
| B | ON | B | OFF | Linear 0° (H) |
| B | OFF | B | ON | Linear 90° (V) |
| B | ON | B | ON | Linear 45° |
| A | X | C | X | CP:CCW |
| C | X | A | X | CP:CW |

In some demonstrative aspects, as shown in Table (1), controller 1040 may be configured to configure polarization-control circuitry 1002, e.g., polarization control circuitry 1202 (FIG. 12) or polarization control circuitry 1332 (FIG. 13), according to a selected linear polarization, for example, by configuring the first-path switches S1a and S2a of the first-path phase shifter Ant Pol1, and the second-path switches S1b and S2b of the second-path phase shifter Ant Pol2 to the predefined phase-shift setting B, and by configuring the first-path switch S3a and second-path switch S3b, e.g., as described below.

In some demonstrative aspects, as shown in Table (1), controller 1040 may be configured to configure the polarization-control circuitry 1002, e.g., polarization control circuitry 1202 (FIG. 12) and/or polarization control circuitry 1332 (FIG. 13), according to the selected linear polarization, for example, by configuring only the first-path switch S3a to the on state, e.g., according to a high-pass setting, by configuring only the second-path switch S3b to the on state, e.g., according to a low-pass setting, or by configuring both the first-path switch S3a and second-path switch S3b to the on state, e.g., according to an all pass setting.

In some demonstrative aspects, as shown in Table (1), controller 1040 may be configured to configure the polarization-control circuitry 1002, e.g., polarization control circuitry 1202 (FIG. 12) and/or polarization control circuitry 1332 (FIG. 13), according to the horizontal polarization, for example, by configuring the first-path switch S3a to the on state, and by configuring the second-path switch S3b to the off state, e.g., according to the high-pass setting.

In some demonstrative aspects, as shown in Table (1), controller 1040 may be configured to configure the polarization-control circuitry 1002, e.g., polarization control circuitry 1202 (FIG. 12) and/or polarization control circuitry 1332 (FIG. 13), according to the vertical polarization, for example, by configuring the first-path switch S3a to the off-state, and by configuring the second-path switch S3b to the on-state, e.g., the low-pass setting.

In some demonstrative aspects, as shown in Table (1), controller 1040 may be configured to configure the polarization-control circuitry 1002, e.g., polarization control circuitry 1202 (FIG. 12) and/or polarization control circuitry 1332 (FIG. 13), according to a 45 degree linear polarization, for example, by configuring the first-path switch S3a to the on state, and by configuring the second-path switch S3b to the on state, e.g., according to the all-pass setting.

In some demonstrative aspects, as shown in Table (1), controller 1040 may be configured to configure the polarization-control circuitry 1002, e.g., polarization control circuitry 1202 (FIG. 12) and/or polarization control circuitry 1332 (FIG. 13), according to a selected circular polarization, for example, by configuring the first-path switches S1a and S2a of the first-path phase shifter Ant Pol1 to one of the predefined phase-shift setting A and the predefined phase-shift setting C, and by configuring the second-path switches S1b and S2b of the second-path phase shifter Ant Pol2 to one of the predefined phase-shift setting A and the predefined phase-shift setting C, e.g., as described below.

In some demonstrative aspects, as shown in Table (1), controller 1040 may be configured to configure the polarization-control circuitry 1002, e.g., polarization control circuitry 1202 (FIG. 12) and/or polarization control circuitry 1332 (FIG. 13), according to a CCW circular polarization, for example, by configuring the first-path switches S1a and S2a of the first-path phase shifter Ant Pol1 to the predefined phase-shift setting A, and by configuring the second-path switches S1b and S2b of the second-path phase shifter Ant Pol2 to the predefined phase-shift setting C.

For example, according to the CCW circular polarization setting, the first-path phase shifter Ant Pol1 may apply a +45 degree phase shift to a first signal via a horizontal port, and the second-path phase shifter Ant Pol2 may apply a −45 degree phase shift to a second signal via a vertical port. For example, this setting may result in a CCW circular polarization of a communicated signal, which may be based on a combination of the first signal and the second signal.

In some demonstrative aspects, as shown in Table (1), controller 1040 may be configured to configure the polarization-control circuitry 1002, e.g., polarization control circuitry 1202 (FIG. 12) and/or polarization control circuitry 1332 (FIG. 13), according to a CW circular polarization, for example, by configuring the first-path switches S1a and S2a of the first-path phase shifter Ant Pol1 to the predefined phase-shift setting C, and by configuring the second-path switches S1b and S2b of the second-path phase shifter Ant Pol2 to the predefined phase-shift setting A.

For example, according to the CW circular polarization setting, the first-path phase shifter Ant Pol1 may apply a −45 degree phase shift to a first signal via a horizontal port, and the second-path phase shifter Ant Pol2 may apply a +45 phase shift to a second signal via a vertical port. For example, this setting may result in a CW circular polarization of a communicated signal, which may be based on a combination of the first signal and the second signal.

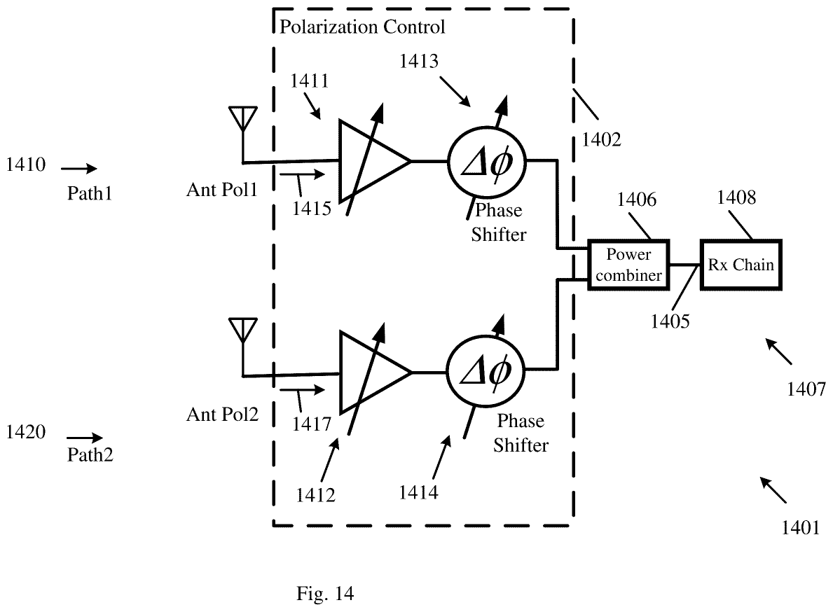

Reference is made to FIG. 14, which schematically illustrates Rx circuitry 1401 including Rx polarization-control circuitry 1402, in accordance with some demonstrative aspects. For example, polarization control circuitry 1002 (FIG. 10) may include one or more elements of Rx polarization-control circuitry 1402, and/or may perform one or more operations and/or functionalities of Rx polarization-control circuitry 1402.

In some demonstrative aspects, Rx polarization control circuitry 1402 may be configured to control a polarization of an Rx signal 1405, for example, according to an Rx polarization setting.

In some demonstrative aspects, as shown in FIG. 14, Rx circuitry 1401 may include a first Rx path 1410, denoted Path1, and a second Rx path 1420, denoted Path2.

In some demonstrative aspects, as shown in FIG. 14, the first Rx path 1410 may be connected to a first antenna port corresponding to a first polarization, e.g., a horizontal polarization.

In some demonstrative aspects, as shown in FIG. 14, the first Rx path 1410 may be configured to receive a first Rx signal 1415 via the first antenna port.

In some demonstrative aspects, as shown in FIG. 14, the second Rx path 1420 may be connected to a second antenna port corresponding to a second polarization, e.g., a vertical polarization.

In some demonstrative aspects, as shown in FIG. 14, the second Rx path 1420 may be configured to receive a second Rx signal 1417 via the second antenna port.

In some demonstrative aspects, as shown in FIG. 14, the first Rx path 1410 may include an LNA 1411, and a variable phase shifter 1413.

In some demonstrative aspects, as shown in FIG. 14, the second RX path 1420 may include an LNA 1412, and a variable phase shifter 1414.

In some demonstrative aspects, as shown in FIG. 14, Rx polarization control circuitry 1402 may include a dual-LNA-phase-shifter topology, for example, where an LNA, e.g., LNA 1411 and/or LNA 1412, may have a gain control, and/or a phase shifter, e.g., phase shifter 1413 and/or phase shifter 1414, may have an offset feature, for example, to provide a technical solution to support substantially any relative phase and/or amplitude between signals received via the first path 1410 and the second path 1420 of the Rx circuitry.

In some demonstrative aspects, each LNA of the LNAs of the Rx polarization control circuitry 1402 may have a gain control, and/or each phase shifter of the phase shifters of the Rx polarization control circuitry 1402 may have an offset feature.

In other aspects, only one LNA of the LNAs of the Rx polarization control circuitry 1402 may have a gain control, and/or only one phase shifter of the phase shifters of the Rx polarization control circuitry may have an offset feature.

In some demonstrative aspects, as shown in FIG. 14, Rx circuitry 1401 may include Rx processing circuitry 1407, which may be connected to the first Rx path 1410 and to the second Rx path 1420 of Rx circuitry 1401.

In some demonstrative aspects, as shown in FIG. 14, Rx circuitry 1401 may include a power combiner 1406, and Rx chain circuitry 1408.

In some demonstrative aspects, as shown in FIG. 14, power combiner 1406 may be configured to combine the first Rx signal 1415 from an output of variable phase shifter 1413, and the second Rx signal 1417 from an output of variable phase shifter 1414, for example, into the Rx signal 1405 to be processed by the Rx chain circuitry 1408.

In some demonstrative aspects, controller 1040 (FIG. 10) may be configured to configure LNA 1411, LNA 1412, variable phase shifter 1413, and/or variable phase shifter 1414, for example, to apply a phase offset between the first Rx signal 1415 in the first Rx path 1410 and the second Rx signal 1417 in the second Rx path 1420. For example, the phase shift may be configured, such that a polarization of the Rx signal 1405 may include the Rx polarization setting, for example, based on the combination of the first Rx signal 1415 and the second Rx signal 1417, at the output of combiner 1406, e.g., as described below.

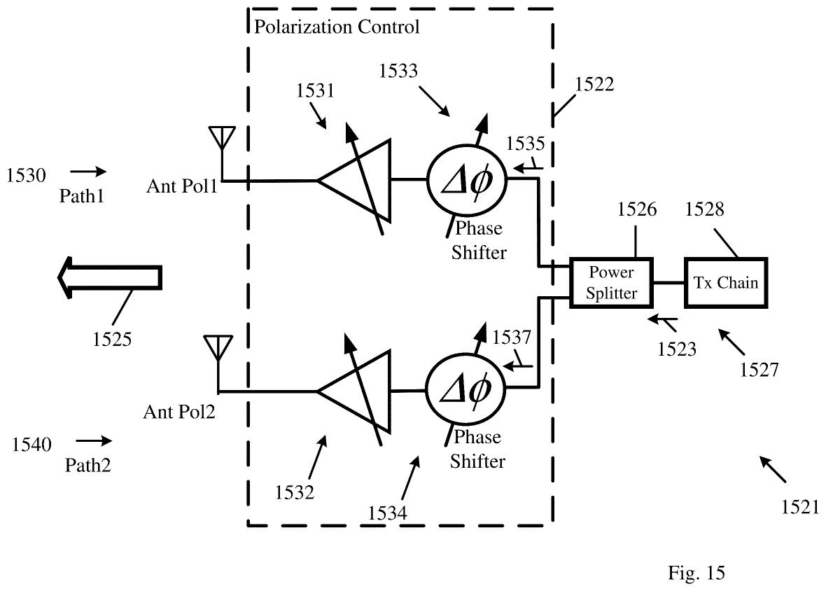

Reference is made to FIG. 15, which schematically illustrates Tx circuitry 1521 including Tx polarization-control circuitry 1522, in accordance with some demonstrative aspects. For example, polarization control circuitry 1002 (FIG. 10) may include one or more elements of Tx polarization-control circuitry 1522, and/or may perform one or more operations and/or functionalities of Tx polarization-control circuitry 1522.

In some demonstrative aspects, Tx polarization control circuitry 1522 may be configured to control a polarization of a Tx signal 1525, for example, according to a Tx polarization setting.

In some demonstrative aspects, as shown in FIG. 15, Tx circuitry 1521 may include a first Tx path 1530, denoted Path1, and a second Tx path 1540, denoted Path2.

In some demonstrative aspects, as shown in FIG. 15, the first Tx path 1530 may be connected to a first antenna port corresponding to a first polarization, e.g., a horizontal polarization.

In some demonstrative aspects, as shown in FIG. 15, the first Tx path 1530 may be configured to transmit a first Tx signal 1535 via the first antenna port.

In some demonstrative aspects, as shown in FIG. 15, the first Tx path 1530 may include a PA 1531, and a variable phase shifter 1533.

In some demonstrative aspects, as shown in FIG. 15, the second Tx path 1540 may be connected to a second antenna port corresponding to a second polarization, e.g., a vertical polarization.

In some demonstrative aspects, as shown in FIG. 15, the second Tx path 1540 may be configured to transmit a second Tx signal 1537 via the second antenna port.

In some demonstrative aspects, as shown in FIG. 15, the second Tx path of Tx circuitry 1521 may include a PA 1532, and a variable phase shifter 1534.

In some demonstrative aspects, as shown in FIG. 15, Tx polarization control circuitry 1522 may include a dual-PA-phase-shifter topology, for example, where a PA, e.g., PA 1531 and/or PA 1532, may have a gain control, and/or a phase shifter, e.g., phase shifter 1533 and/or phase shifter 1534, may have an offset feature, for example, to provide a technical solution to support sustainably any relative phase and/or amplitude between signals transmitted via the first path 1530 and the second path 1540 of the Tx circuitry 1521.

In some demonstrative aspects, each PA of the PAs of the Tx polarization control circuitry 1522 may have a gain control, and/or each phase shifter of the phase shifters of the Tx polarization control circuitry 1522 may have an offset feature.

In other aspects, only one PA of the PAs of the Tx polarization control circuitry 1522 may have a gain control, and/or only one phase shifter of the phase shifters of the Tx polarization control circuitry 1522 may have an offset feature.

In some demonstrative aspects, as shown in FIG. 15, Tx circuitry 1521 may include Tx processing circuitry 1527, which may be connected to the first Tx path 1530 and to the second Tx path 1540.

In some demonstrative aspects, as shown in FIG. 15, Tx circuitry 1501 may include a power splitter 1526, and Tx chain circuitry 1528.

In some demonstrative aspects, as shown in FIG. 15, power splitter 1526 may be configured to split a Tx signal 1523 from Tx chain circuitry 1528, for example, into the first Tx signal 1535 to be phase-shifted by phase shifter 1533 and to be amplified by PA 1531, and the second Tx signal 1537 to be phase shifted by phase shifter 1534 and to be amplified by PA 1532.

In some demonstrative aspects, as shown in FIG. 15, Tx signal 1525 may be based on a combination of the first Tx signal 1535, e.g., transmitted via the first antenna port, and the second Tx signal 1537, e.g., transmitted via the second antenna port.

In some demonstrative aspects, controller 1040 (FIG. 10) may be configured to configure PA 1531, PA 1532, variable phase shifter 1533, and/or variable phase shifter 1534, for example, to apply a phase offset between the first Tx signal 1535 in the first Tx path 1530 and the second Tx signal 1537 in the second Tx path 1540. For example, the phase shift may be configured such that the polarization of Tx signal 1525 may be set according to the Tx polarization setting.

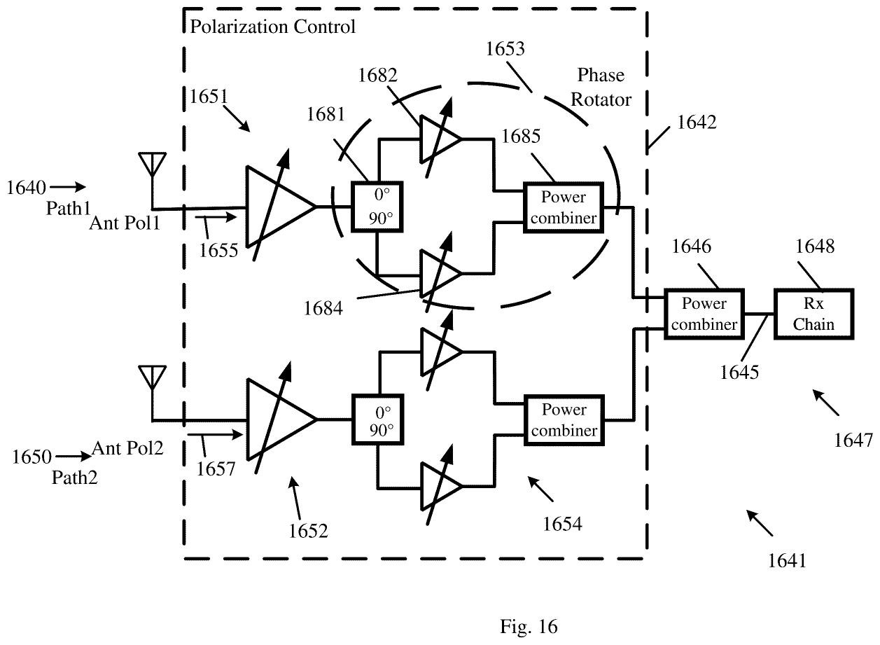

Reference is made to FIG. 16, which schematically illustrates Rx circuitry 1641 including Rx polarization-control circuitry 1642, in accordance with some demonstrative aspects. For example, polarization control circuitry 1002 (FIG. 10) may include one or more elements of Rx polarization-control circuitry 1642, and/or may perform one or more operations and/or functionalities of Rx polarization-control circuitry 1642.

In some demonstrative aspects, as shown in FIG. 16, Rx polarization control circuitry 1642 may be configured to control a polarization of an Rx signal 1645, for example, according to an Rx polarization setting.

In some demonstrative aspects, as shown in FIG. 16, Rx circuitry 1641 may include a first Rx path 1640, denoted Path1, and a second Rx path 1650, denoted Path2.

In some demonstrative aspects, as shown in FIG. 16, the first Rx path 1640 may be connected to a first antenna port corresponding to a first polarization, e.g., a horizontal polarization.

In some demonstrative aspects, as shown in FIG. 16, the first Rx path 1640 may be configured to receive a first Rx signal 1655 via the first antenna port.

In some demonstrative aspects, as shown in FIG. 16, the second Rx path 1650 may be connected to a second antenna port corresponding to a second polarization, e.g., a vertical polarization.

In some demonstrative aspects, as shown in FIG. 16, the second Rx path 1650 may be configured to receive a second Rx signal 1657 via the second antenna port.

In some demonstrative aspects, as shown in FIG. 16, the first Rx path 1640 may include an LNA 1651, and a phase rotator 1653.

In some demonstrative aspects, as shown in FIG. 16, the second Rx path 1650 may include an LNA 1652, and a phase rotator 1654.

In some demonstrative aspects, as shown in FIG. 16, Rx polarization control circuitry 1642 may include a dual-LNA-phase-rotator topology, for example, where an LNA, e.g., LNA 1651 and/or LNA 1652, may have a gain control, and/or a phase rotator, e.g., phase rotator 1653 and/or phase rotator 1654, may have an offset feature, for example, to provide a technical solution to support substantially any relative phase and/or amplitude between signals received via the first path 1640 and the second path 1650 of the Rx circuitry 1641.

In some demonstrative aspects, each LNA of the LNAs of the Rx polarization control circuitry 1642 may have a gain control, and/or each phase rotator of the phase rotators of the Rx polarization control circuitry 1642 may have an offset feature.

In other aspects, only one LNA of the LNAs of the Rx polarization control circuitry 1642 may have a gain control, and/or only one phase shifter of the phase shifters of the Rx polarization control circuitry 1642 may have an offset feature. For example, Rx polarization control circuitry 1642 may include a single variable phase shifter, and/or a single gain-controlled LNA.

In some demonstrative aspects, as shown in FIG. 16, a phase rotator, e.g., phase rotator 1653 and/or phase rotator 1654, may include a 90-degree phase shifter 1681, a phase-rotator power combiner 1685, and a first variable gain amplifier 1682 and a second variable gain amplifier 1684, e.g., connected in parallel between the 90-degree phase shifter 1681 and the phase-rotator power combiner 1685.

In some demonstrative aspects, as shown in FIG. 16, Rx circuitry 1641 may include Rx processing circuitry 1647, which may be connected to the first Rx path 1640, and to the second Rx path 1650 of Rx circuitry 1641.

In some demonstrative aspects, as shown in FIG. 16, Rx circuitry 1641 may include a power combiner 1646, and Rx chain circuitry 1648.

In some demonstrative aspects, as shown in FIG. 16, power combiner 1646 may be configured to combine the first Rx signal 1655 from an output of phase rotator 1653, and the second Rx signal 1657 from an output of phase rotator 1654, for example, into the Rx signal 1645 to be processed by the Rx chain circuitry 1648.

In some demonstrative aspects, controller 1040 (FIG. 10) may be configured to configure LNA 1651, LNA 1652, phase rotator 1652, and/or phase rotator 1654, for example, to apply a phase offset between the first Rx signal 1655 in the first Rx path 1640 and the second Rx signal 1657 in the second Rx path 1650. For example, the phase shift may be configured such that a polarization of the Rx signal 1645 may include the Rx polarization setting, for example, based on the combination of the first Rx signal 1455 and the second Rx signal 1657, at the output of combiner 1646, e.g., as described below.

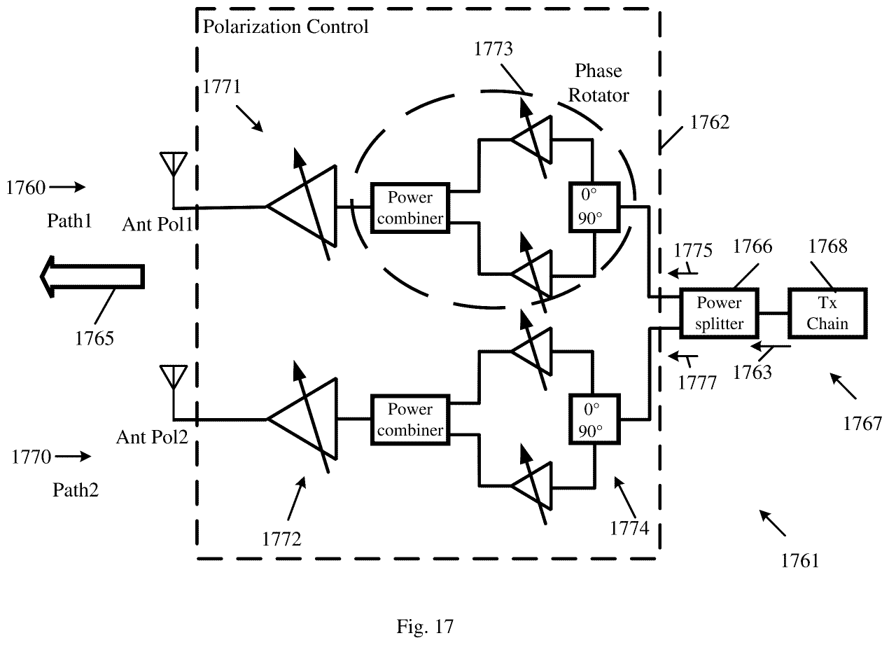

Reference is made to FIG. 17, which schematically illustrates Tx circuitry 1761 including Tx polarization-control circuitry 1762, in accordance with some demonstrative aspects. For example, polarization control circuitry 1002 (FIG. 10) may include one or more elements of Tx polarization-control circuitry 1762, and/or may perform one or more operations and/or functionalities of Tx polarization-control circuitry 1762.

In some demonstrative aspects, Tx polarization control circuitry 1762 may be configured to control a polarization of a Tx signal 1765, for example, according to a Tx polarization setting.

In some demonstrative aspects, as shown in FIG. 17, Tx circuitry 1761 may include a first Tx path 1760, denoted Path1, and a second Tx path 1770, denoted Path2.

In some demonstrative aspects, as shown in FIG. 17, the first Tx path 1760 may be connected to a first antenna port corresponding to a first polarization, e.g., a horizontal polarization.

In some demonstrative aspects, as shown in FIG. 17, the first Tx path 1760 may be configured to transmit a first Tx signal 1775 via the first antenna port.

In some demonstrative aspects, as shown in FIG. 17, the second Tx path 1770 may be connected to a second antenna port corresponding to a second polarization, e.g., a vertical polarization.

In some demonstrative aspects, as shown in FIG. 17, the second Tx path 1770 may be configured to transmit a second Tx signal 1777 via the second antenna port.

In some demonstrative aspects, as shown in FIG. 17, the first Tx path 1760 may include a PA 1771, and a phase rotator 1773.

In some demonstrative aspects, as shown in FIG. 17, the second Tx path 1770 may include a PA 1772, and a phase rotator 1774.

In some demonstrative aspects, as shown in FIG. 17, phase rotator 1774 and/or phase rotator 1773 may include one or more of the components of phase rotator 1653 (FIG. 16).

In some demonstrative aspects, as shown in FIG. 17, Tx polarization control circuitry 1762 may include a dual-PA-phase-rotator topology, for example, where a PA, e.g., PA 1771 and/or PA 1772, may have a gain control, and/or a phase rotator, e.g., phase rotator 1773 and/or phase rotator 1774, may have an offset feature, for example, to provide a technical solution to support sustainably any relative phase and/or amplitude between signals transmitted via the first path 1760 and the second path 1770 of the Tx circuitry 1761.

In some demonstrative aspects, each PA of the PAs of the Tx polarization control circuitry 1762 may have a gain control, and/or each phase rotator of the phase rotators of the Tx polarization control circuitry 1762 may have an offset feature.

In other aspects, only one PA of the PAs of the Tx polarization control circuitry 1762 may have a gain control, and/or only one phase shifter of the phase shifters of the Tx polarization control circuitry 1762 may have an offset feature. For example, Tx polarization control circuitry 1762 may include a single variable phase shifter, and/or a single gain-controlled LNA.

In some demonstrative aspects, as shown in FIG. 17, Tx circuitry 1761 may include Tx processing circuitry 1767, which may be connected to the first Tx path 1760 and to the second Tx path 1770 of Tx circuitry 1761.

In some demonstrative aspects, as shown in FIG. 17, Tx circuitry 1761 may include a power splitter 1766, and Tx chain circuitry 1768.

In some demonstrative aspects, as shown in FIG. 17, power splitter 1766 may be configured to split a Tx signal 1763 from Tx chain circuitry 1768, for example, into the first Tx signal 1775 to be phase shifted by phase rotator 1773 and to be amplified by PA 1771, and the second Tx signal 1777 to be phase shifted by phase rotator 1774 and to be amplified by PA 1772.

In some demonstrative aspects, as shown in FIG. 17, Tx signal 1765 may be based on a combination of the first Tx signal 1775, e.g., transmitted via the first antenna port, and the second Tx signal 1777, e.g., transmitted via the second antenna port.

In some demonstrative aspects, controller 1040 (FIG. 10) may be configured to configure PA 1771, PA 1772, phase rotator 1772, and/or phase rotator 1774, for example, to apply a phase offset between the first Tx signal 1775 in the first Tx path 1760 and the second Tx signal 1777 in the second Tx path 1770. For example, the phase shift may be configured such that the polarization of Tx signal 1765 may include the Tx polarization setting.

In some demonstrative aspects, phase-rotator-based polarization control circuitry, e.g., Rx polarization control circuitry 1642 (FIG. 16) and/or Tx polarization control circuitry 1762, may be configured to provide a technical solution to support a compact implementation, e.g., to cover an entire 0-360° phase offset.

In some demonstrative aspects, the variable gain amplifiers of a phase-rotator 1653, e.g., variable gain amplifier 1682 (FIG. 16) and/or variable gain amplifier 1684 (FIG. 16), may be utilized, for example, to weight differently signals via a first path and a second path of the phase-rotator-based RF circuitry, for example to provide a technical solution to support substantially any elliptical, circular, and/or linear polarizations, e.g., within a predefined range of polarizations. For example, the variable gain amplifiers of the phase-rotator 1653 may be implemented to provide a technical solution to support implementation of fixed-gain amplifiers, e.g., LNA 1651 (FIG. 16) and/or LNA 1652 (FIG. 16), and/or PA 1771 and/or PA 1772. For example, the implementation of the fixed-gain amplifiers may provide a technical solution utilizing a simple implementation of standard LNAs and/or PAs.

In some demonstrative aspects, amplifiers of the phase-rotator-based polarization control circuitry, e.g., LNA 1651 (FIG. 16), LNA 1652 (FIG. 16), PA 1771, and/or PA 1772, may be implemented utilizing variable gain amplifiers, for example, to enhance a dynamic range of the weighting between the paths of the polarization control circuitry.

In some demonstrative aspects, phase-rotator-based polarization control circuitry, e.g., Rx polarization control circuitry 1642 (FIG. 16), and/or Tx polarization control circuitry 1762, may be configured to provide a technical solution to support correction of a polarization, e.g., in terms of degrees and/or an axial ratio, for example, of an element, e.g., every element, in an antenna array. For example, this configuration may be implemented, for example, to achieve a very good cross-polarization and/or axial ratio of the entire antenna array, for example, at every observation and/or steering angle of the antenna array.

In one example, a circularly polarized antenna may be limited to a certain axial-ratio over its entire field of view or its radiation pattern. For example, the circular polarization of the circularly polarized antenna may deteriorate, e.g., as a difference between the observation angle and the boresight increases. Accordingly, it may be advantageous to be able to configure an array of elements, which are all in a circular polarization, and which may allow a wide range of scanning angles with good cross polarization over the entire required field of view.

In some demonstrative aspects, a covered range of a phase shifter may be higher than a ±90° phase shift, which may be required for purely circular polarization, for example, in order to correct a polarization, e.g., in terms of degrees and/or axial ratio, for example, at every observation and/or steering angle of the antenna array.

In some demonstrative aspects, phase-rotator-based polarization control circuitry, e.g., Rx polarization control circuitry 1642 (FIG. 16) and/or Tx polarization control circuitry 1762, may be configured to support a full 0-360° phase shift range, for example, with substantially a same effort as may be required to cover the 0-90° phase shift range. For example, this may be compared to other phase shifter topologies, which may require higher volume and complexity, e.g., as the required phase offset range increases.

Referring back to FIG. 10, in some demonstrative aspects, controller 1040 may be configured to control RF circuitry, e.g., Rx circuitry 1401 (FIG. 14), Tx circuitry 1521 (FIG. 15), Rx circuitry 1641 (FIG. 16), and/or Tx circuitry 1761 (FIG. 17), for example, to control a polarization for a communicated signal via the RF circuitry, for example, according to a polarization setting, e.g., as described below.

In some demonstrative aspects, controller 1040 may be configured to control the RF circuitry, for example, according to a selected polarization from a plurality of polarization settings.

In some demonstrative aspects, controller 1040 may be configured to control the RF circuitry, for example, by configuring a first-path amplifier, denoted Ant Pol1 Gain, a first-path phase shifter, denoted Ant Pol1 Phase, a second-path amplifier, denoted Ant Pol2 Gain, and a second-path phase shifter, denoted Ant Pol2 Phase, for example, according to the selected polarization from the plurality of polarization settings.

In one example, controller 1040 may be configured to control a polarization of Rx signal 1405 (FIG. 14) received by Rx circuitry 1401 (FIG. 14), for example, by configuring the LNA 1411 (FIG. 14), the phase shifter 1413 (FIG. 14), the LNA 1412 (FIG. 14), and the phase shifter 1414 (FIG. 14), for example, according to a selected polarization from the plurality of polarization settings.

In another example, controller 1040 may be configured to control a polarization of Tx signal 1525 (FIG. 15) transmitted by Tx circuitry 1521, for example, by configuring the PA 1531 (FIG. 15), the phase shifter 1533 (FIG. 15), the PA 1532 (FIG. 15), and the phase shifter 1534 (FIG. 15), for example, according to a selected polarization from the plurality of polarization settings.

In another example, controller 1040 may be configured to control a polarization of Rx signal 1645 (FIG. 16) received by Rx circuitry 1641 (FIG. 16), for example, by configuring the LNA 1651 (FIG. 16), the phase rotator 1653 (FIG. 16), the LNA 1652 (FIG. 16), and the phase rotator 1654 (FIG. 16), for example, according to a selected polarization from the plurality of polarization settings.

In another example, controller 1040 may be configured to control a polarization of Tx signal 1765 (FIG. 16) transmitted by Tx circuitry 1761 (FIG. 16), for example, by configuring the PA 1771 (FIG. 16), the phase rotator 1773 (FIG. 16), the PA 1772 (FIG. 16), and the phase rotator 1774 (FIG. 16), for example, according to a selected polarization from the plurality of polarization settings.

In one example, the plurality of polarization settings may include a plurality of predefined polarization settings, e.g., as follows:

TABLE 2

| Ant Pol1 | Ant Pol1 | Ant Pol2 | Ant Pol2 | |
|---|---|---|---|---|
| Gain | Phase | Gain | Phase | Tx/Rx Pol |
| Max | 0° | Min | X | Linear 0° (H) |
| Min | X | Max | 0° | Linear 90° (V) |
| Max | 0° | Max | 0° | Linear 45° |
| Max | 45° | Max | −45° | CP:CCW |
| Max | −45° | Max | 45° | CP:CW |
| Max | −45° | 0.5Max | 45° | CW Elliptical |
| | | (Max-3 dB) | | Polarization |
| | | | | with axial ratio of 1:2 |

For example, the first-path amplifier Ant Pol1 Gain and the second-path amplifier Ant Pol2 Gain according to Table 2 may be implemented, for example, in case of no power normalization.

For example, the first-path amplifier Ant Pol1 Gain and the second-path amplifier Ant Pol2 Gain according to Table 2 may be configured with a relation of a sine function and a cosine function, e.g., in a case power normalization is implemented.

In one example, a 45° linear polarization with power normalization may be configured, for example, by configuring the first-path amplifier Ant Pol1 Gain to

$$\frac{\sqrt{2}}{2}$$

of the maximal gain, and the second-path amplifier Ant Pol2 Gain to

$$\frac{\sqrt{2}}{2}$$

of the maximal gain.

In some demonstrative aspects, as shown in Table (2), controller 1040 may be configured to configure the RF circuitry according to the horizontal polarization, for example, by configuring the first-path amplifier Ant Pol1 Gain to apply a maximal gain, the first-path phase shifter Ant Pol1 Phase to apply a “0” degree phase shift, and the second-path amplifier Ant Pol2 Gain to apply a minimal gain.

In some demonstrative aspects, as shown in Table (2), controller 1040 may be configured to configure the RF circuitry according to the vertical polarization, for example, by configuring the first-path amplifier Ant Pol1 Gain to apply a minimal gain, the second-path amplifier Ant Pol2 Gain to apply a maximal gain, and the second-path phase shifter Ant Pol2 Phase to apply a “0” degree phase shift.

In some demonstrative aspects, as shown in Table (2), controller 1040 may be configured to configure the RF circuitry according to the 45° linear polarization, for example, by configuring the first-path amplifier Ant Pol1 Gain to apply a maximal gain, the first-path phase shifter Ant Pol1 Phase to apply a “0” degree phase shift, the second-path amplifier Ant Pol2 Gain to apply a maximal gain, and the second-path phase shifter Ant Pol2 Phase to apply a “0” degree phase shift.

In some demonstrative aspects, controller 1040 may be configured to configure the RF circuitry according to sustainably any other linear polarization within a predefined range of linear polarizations, for example, by configuring the first-path amplifier Ant Pol1 Gain, the first-path phase shifter Ant Pol1 Phase, the second-path amplifier Ant Pol2 Gain, and/or the second-path phase shifter Ant Pol2 Phase according to any other predefined combination and/or configuration.

In some demonstrative aspects, as shown in Table (2), controller 1040 may be configured to configure the RF circuitry according to a CP CCW polarization, for example, by configuring the first-path amplifier Ant Pol1 Gain to apply a maximal gain, the first-path phase shifter Ant Pol1 Phase to apply a “45” degree phase shift, the second-path amplifier Ant Pol2 Gain to apply a maximal gain, and the second-path phase shifter Ant Pol2 Phase to apply a “−45” degree phase shift.

In some demonstrative aspects, as shown in Table (2), controller 1040 may be configured to configure the RF circuitry according to a CP CW polarization, for example, by configuring the first-path amplifier Ant Pol1 Gain to apply a maximal gain, the first-path phase shifter Ant Pol1 Phase to apply a “−45” degree phase shift, the second-path amplifier Ant Pol2 Gain to apply a maximal gain, and the second-path phase shifter Ant Pol2 Phase to apply a “45” degree phase shift.

In some demonstrative aspects, controller 1040 may be configured to configure the RF circuitry according to sustainably any other CP polarization within a predefined range of circular polarizations, for example, by configuring the first-path amplifier Ant Pol1 Gain, the first-path phase shifter Ant Pol1 Phase, the second-path amplifier Ant Pol2 Gain, and/or the second-path phase shifter Ant Pol2 Phase according to any other predefined combination and/or configuration.

In some demonstrative aspects, as shown in Table (2), controller 1040 may be configured to configure the RF circuitry according to an elliptical polarization with an axial ratio of 1:2, for example, by configuring the first-path amplifier Ant Pol1 Gain to apply a maximal gain, the first-path phase shifter Ant Pol1 Phase to apply a “−45” degree phase shift, the second-path amplifier Ant Pol2 Gain to apply a half of the maximal gain, e.g., a half of −3 dB gain, and the second-path phase shifter Ant Pol2 Phase to apply a “45” degree phase shift.

In some demonstrative aspects, controller 1040 may be configured to configure the RF circuitry according to sustainably any other elliptical polarization within a predefined range of elliptical polarizations with any other axial ratio within a predefined range of axel ratios, for example, by configuring the first-path amplifier Ant Pol1 Gain, the first-path phase shifter Ant Pol1 Phase, the second-path amplifier Ant Pol2 Gain, and/or the second-path phase shifter Ant Pol2 Phase according to any other predefined combination and/or configuration.

In some demonstrative aspects, processing circuitry 1006 may include baseband processing circuitry, e.g., as described below.

In some demonstrative aspects, baseband processing circuitry 1006 may include Rx baseband circuitry, which may be configured to combine a first Rx signal and a second Rx signal into a combined Rx signal at a baseband part of an Rx chain, e.g., as described below.

In some demonstrative aspects, baseband processing circuitry 1006 may include Tx baseband circuitry, which may be configured to split a Tx signal into a first Tx signal and a second Tx signal, for example, at a baseband part of a Tx chain, e.g., as described below.

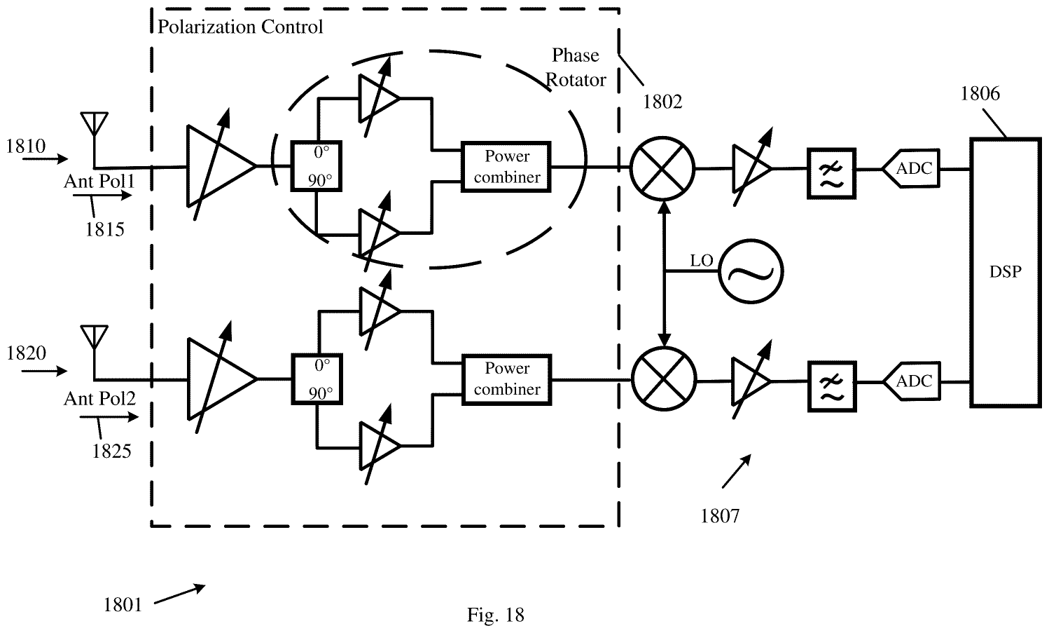

Reference is made to FIG. 18 which schematically illustrates Rx circuitry 1801 including Rx polarization-control circuitry 1802, in accordance with some demonstrative aspects. For example, polarization control circuitry 1002 (FIG. 10) may include one or more elements of Rx polarization-control circuitry 1802, and/or may perform one or more operations and/or functionalities of Rx polarization-control circuitry 1802.

In some demonstrative aspects, as shown in FIG. 18, Rx polarization-control circuitry 1802 may include dual-LNA-phase-rotator polarization control circuitry, e.g., Rx polarization-control circuitry 1642 (FIG. 16).

In some demonstrative aspects, as shown in FIG. 18, Rx polarization-control circuitry 1802 may include a first Rx path 1810, which may be configured to receive a first Rx signal 1815 via a first antenna port, denoted Ant Pol1, according to a first polarization, e.g., the horizontal polarization.

In some demonstrative aspects, as shown in FIG. 18, Rx polarization-control circuitry 1802 may include a second Rx path 1820, which may be configured to receive a second Rx signal 1825 via a second antenna port, denoted Ant Pol1, according to a second polarization, e.g., the vertical polarization.

In some demonstrative aspects, as shown in FIG. 18, Rx circuitry 1801 may include Rx processing circuitry 1807, which may be connected to the first Rx path 1810 and to the second Rx path 1820.

In some demonstrative aspects, as shown in FIG. 18, Rx processing circuitry 1807 may include Rx baseband processing circuitry.

In some demonstrative aspects, as shown in FIG. 18, Rx processing circuitry 1807 may include a baseband processor 1806, e.g., a DSP and/or any other baseband processor.

In some demonstrative aspects, as shown in FIG. 18, first Rx signal 1815 from the first Rx path 1810 and second Rx signal 1825 from the second Rx path 1820 may be combined, for example, at baseband processor 1806.

In some demonstrative aspects, as shown in FIG. 18, an implementation utilizing Rx processing circuitry 1807 may require more physical area for implementation, and/or may consume more power, for example, compared to an implementation utilizing analog processing circuitry, e.g., processing circuitry 1647 (FIG. 16). For example, as shown in FIG. 18, the Rx digital-based processing circuitry 1807 may be configured to support two parallel downconverter chains and two ADCs.

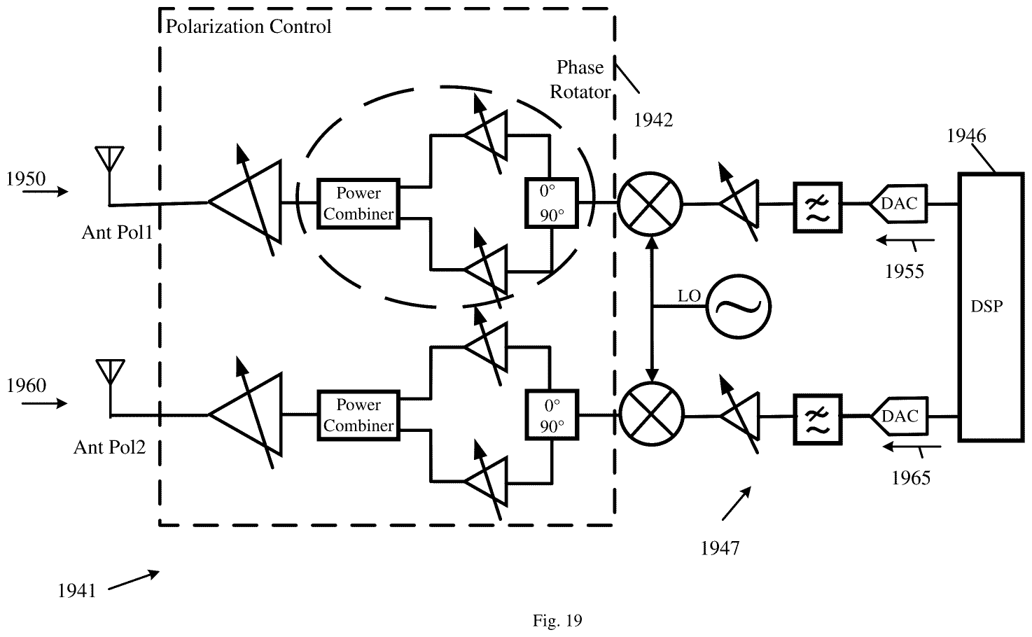

Reference is made to FIG. 19 which schematically illustrates Tx circuitry 1941 including Tx polarization-control circuitry 1942, in accordance with some demonstrative aspects. For example, polarization control circuitry 1002 (FIG. 10) may include one or more elements of Tx polarization-control circuitry 1942, and/or may perform one or more operations and/or functionalities of Tx polarization-control circuitry 1942.

In some demonstrative aspects, as shown in FIG. 19, Tx polarization-control circuitry 1942 may include dual-PA-phase-rotator polarization control circuitry, e.g., Tx polarization-control circuitry 1762 (FIG. 17).

In some demonstrative aspects, as shown in FIG. 19, Tx polarization-control circuitry 1942 may include a first Rx path 1950, which may be configured to transmit a first Tx signal 1955 via a first antenna port, denoted Ant Pol1, according to a first polarization, e.g., the horizontal polarization.

In some demonstrative aspects, as shown in FIG. 19, Tx polarization-control circuitry 1942 may include a second Tx path 1960, which may be configured to transmit a second Tx signal 1965 via a second antenna port denoted Ant Pol2, according to a second polarization, e.g., the vertical polarization.

In some demonstrative aspects, as shown in FIG. 19, Tx circuitry 1941 may include Tx processing circuitry 1947, which may be connected to the first Tx path 1950 and to the second Tx path 1960.

In some demonstrative aspects, as shown in FIG. 19, Tx processing circuitry 1947 may include Tx digital-based processing circuitry.

In some demonstrative aspects, as shown in FIG. 19, Tx processing circuitry 1947 may include a baseband processor 1946, e.g., a DSP and/or any other baseband processor.

In some demonstrative aspects, as shown in FIG. 19, first Tx signal 1955 in the first Tx path 1950 and second Tx signal 1955 in the second Tx path 1960 may be split from a Tx signal (not shown in FIG. 19), for example, by baseband processor 1946.

In some demonstrative aspects, as shown in FIG. 19, an implementation utilizing Tx processing circuitry 1947, may require more physical area for implementation, and/or may consume more power, for example, compared to an implementation utilizing analog processing circuitry, e.g., processing circuitry 1767 (FIG. 17). For example, as shown in FIG. 18, the Tx digital-based processing circuitry may be configured to support two parallel upconverter chains and two DACs.

In some demonstrative aspects, baseband processing circuitry, e.g., Rx processing circuitry 1807 (FIG. 18) and/or Tx processing circuitry 1947, may be implemented to provide a technical solution to support digitally setting a phase and/or an amplitude of a first RF signal via a first path of polarization control circuitry, and a second RF signal via a second path of the polarization control circuitry.

In some demonstrative aspects, the digitally setting of the phase and/or the amplitude may improve an accuracy, for example, compared to an analog implementation, e.g., as described above with reference to FIG. 16 and FIG. 17. For example, the digitally setting of the phase and/or the amplitude may support a sufficient ADC Effective Number Of Bits (ENOB), and/or a computational accuracy.

In some demonstrative aspects, the baseband processing circuitry may be implemented to provide a technical solution to keep the phase and/or amplitude of each polarization more stable over time, for example, with lower sensitivity to junction temperature and/or ambient temperature.

In some demonstrative aspects, the baseband processing circuitry may be implemented to provide a technical solution to support parallel computation of a MIMO radar, which may support parallel steering of two beams, e.g., a first beam at a first polarization and a second beam at a second polarization.

In some demonstrative aspects, the baseband processing circuitry may be implemented to provide a technical solution to support different combinations of different sub-arrays with different polarizations.

In some demonstrative aspects, the baseband processing circuitry may be implemented to provide a technical solution to support digital combining of two Rx signals received according to two different polarizations, e.g., with appropriate relative amplitude and phase.

In some demonstrative aspects, the baseband processing circuitry may be implemented to provide a technical solution to support a polarization of a Tx signal, which may be digitally set for example, with appropriate relative amplitude and/or phase at both polarization paths.

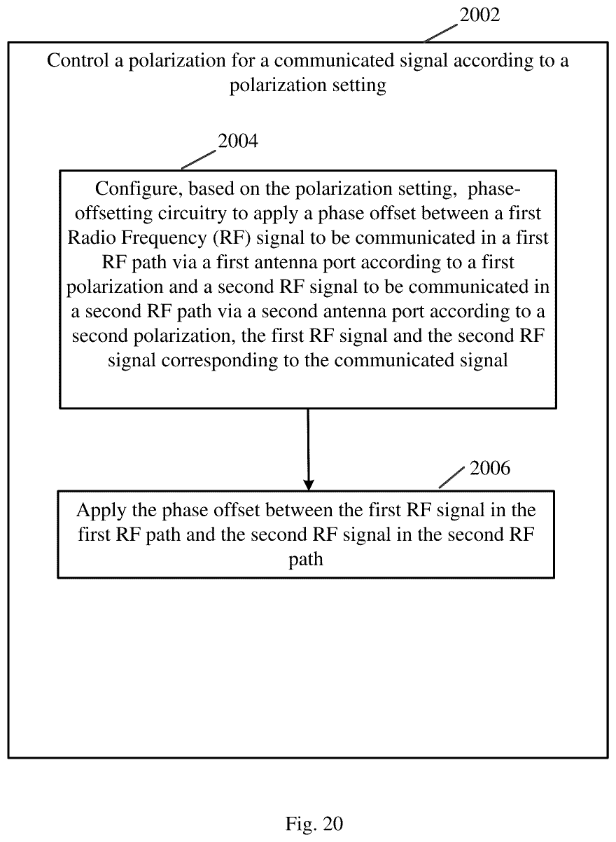

Reference is made to FIG. 20, which schematically illustrates a method of controlling a polarization for a communicated signal, in accordance with some demonstrative aspects. For example, one or more of the operations of the method of FIG. 20 may be performed by a radar system, e.g., radar system 900 (FIG. 9); a radar device, e.g., radar device 800 (FIG. 8); a radar front-end, e.g., radar front-end 804 (FIG. 8); a controller, e.g., controller 1040 (FIG. 10); and/or polarization-control circuitry, e.g., polarization-control circuitry 1002 (FIG. 10).

As indicated at block 2002, the method may include controlling a polarization for a communicated signal according to a polarization setting. For example, polarization control circuitry 1002 (FIG. 10) may control the polarization for the communicated signal, for example, according to the polarization setting 1005 (FIG. 10), e.g., as described above.

As indicated at block 2004, controlling the polarization for the communicated signal may include configuring, based on the polarization setting, phase-offsetting circuitry to apply a phase offset between a first RF signal to be communicated in a first RF path via a first antenna port according to a first polarization, and a second RF signal to be communicated in a second RF path via a second antenna port according to a second polarization. For example, the first RF signal and the second RF signal may correspond to the communicated signal. For example, controller 1040 (FIG. 10) may be configured to configure the phase-offsetting circuitry 1008 (FIG. 10) to apply the phase offset between the first RF signal 1015 (FIG. 10) in the first RF path 1010 (FIG. 10) and the second RF signal 1025 (FIG. 10) in the second RF path 1020 (FIG. 10), for example, based on the polarization setting 1005 (FIG. 10), e.g., as described above.

As indicated at block 2006, controlling the polarization for the communicated signal may include applying the phase offset between the first RF signal in the first RF path and the second RF signal in the second RF path. For example, phase-offsetting circuitry 1008 (FIG. 10) may apply the phase offset between the first RF signal 1015 (FIG. 10) in the first RF path 1010 (FIG. 10) and the second RF signal 1025 (FIG. 10) in the second RF path 1020 (FIG. 10), e.g., as described above.

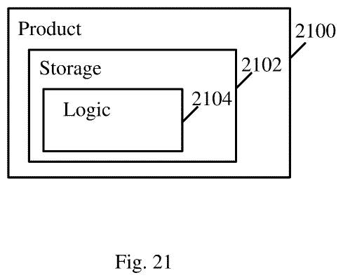

Reference is made to FIG. 21, which schematically illustrates a product of manufacture 2100, in accordance with some demonstrative aspects. Product 2100 may include one or more tangible computer-readable (“machine-readable”) non-transitory storage media 2102, which may include computer-executable instructions, e.g., implemented by logic 2104, operable to, when executed by at least one computer processor, enable the at least one computer processor to implement one or more operations and/or functionalities described with reference to any of the FIGS. 1-20, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 2100 and/or machine-readable storage media 2102 may include one or more types of computer-readable storage media capable of storing data, including volatile memory, non-volatile memory, removable or non-removable memory, erasable or non-erasable memory, writeable or re-writeable memory, and the like. For example, machine-readable storage media 2102 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 2104 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 2104 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising polarization-control circuitry configured to control a polarization for a communicated signal according to a polarization setting, the polarization-control circuitry comprising a first Radio Frequency (RF) path configured to communicate a first RF signal corresponding to the communicated signal via a first antenna port according to a first polarization; a second RF path configured to communicate a second RF signal corresponding to the communicated signal via a second antenna port according to a second polarization; phase-offsetting circuitry comprising at least one phase shifter in at least one path of the first RF path or the second RF path, the phase-offsetting circuitry configurable to apply a phase offset between the first RF signal in the first RF path and the second RF signal in the second RF path; and a controller configured to configure the phase-offsetting circuitry to apply the phase offset based on the polarization setting.

Example 2 includes the subject matter of Example 1, and, optionally, wherein the polarization for the communicated signal is based on the first polarization, the second polarization, and the phase offset.

Example 3 includes the subject matter of Example 1 or 2, and, optionally, wherein the polarization for the communicated signal is based on a combination of the first polarization and the second polarization according to the phase offset.

Example 4 includes the subject matter of any one of Examples 1-3, and, optionally, wherein the controller is configured to configure the phase-offsetting circuitry to apply a first phase offset based on a first polarization setting, and to configure the phase-offsetting circuitry to apply a second phase offset based on a second polarization setting, wherein the first phase offset is different from the second phase offset, and the first polarization setting is different from the second polarization setting.

Example 5 includes the subject matter of any one of Examples 1-4, and, optionally, wherein the phase-offsetting circuitry comprises a first-path phase shifter configurable to apply a first-path phase shift to the first RF signal in the first RF path, and a second-path phase shifter configurable to apply a second-path phase shift to the second RF signal in the second RF path, wherein the controller is configured to configure the first-path phase shifter to apply the first-path phase shift and the second-path phase shifter to apply the second-path phase shift based on the polarization setting.

Example 6 includes the subject matter of any one of Examples 1-5, and, optionally, wherein the phase shifter comprises a variable phase shifter.

Example 7 includes the subject matter of any one of Examples 1-6, and, optionally, wherein the phase shifter comprises a phase rotator.

Example 8 includes the subject matter of any one of Examples 1-7, and, optionally, wherein the first RF path comprises a first amplifier to amplify the first RF signal, and the second RF path comprises a second amplifier to amplify the second RF signal.

Example 9 includes the subject matter of Example 8, and, optionally, wherein at least one amplifier of the first amplifier or the second amplifier comprises an adjustable amplifier, wherein the controller is configured to configure the adjustable amplifier according to a gain difference to be applied between the first RF signal in the first RF path and the second RF signal in the second RF path, wherein the gain difference is based on the polarization setting.

Example 10 includes the subject matter of any one of Examples 1-9, and, optionally, wherein the phase shifter is switchable between a plurality of predefined phase-shifter settings corresponding to a plurality of predefined phase shifts, wherein the controller is configured to set the phase-shifter to a selected phase-shifter setting from the plurality of predefined phase-shifter settings based on the polarization setting.

Example 11 includes the subject matter of Example 10, and, optionally, wherein the phase shifter comprises a plurality of phase-shifter paths corresponding to the plurality of predefined phase-shifter settings, wherein the controller is configured to switch the phase shifter to a selected phase-shifter path of the plurality of phase-shifter paths based on the predefined phase-shift setting.

Example 12 includes the subject matter of Example 10 or 11, and, optionally, wherein the plurality of predefined phase-shift settings comprises three predefined phase-shift settings.

Example 13 includes the subject matter of any one of Examples 10-12, and, optionally, wherein the phase shifter comprises an Inductor (L) Capacitor (C) (LC) circuit.

Example 14 includes the subject matter of any one of Examples 1-13, and, optionally, wherein the communicated signal comprises a Transmit (Tx) signal, wherein the first RF signal and the second RF signal are based on a splitting of the Tx signal.

Example 15 includes the subject matter of Example 14, and, optionally, wherein the first RF path comprises a first Power Amplifier (PA) to amplify the first RF signal to be transmitted via the first antenna port, and the second RF path comprises a second PA to amplify the second RF signal to be transmitted via the second antenna port.

Example 16 includes the subject matter of any one of Examples 1-13, and, optionally, wherein the communicated signal comprises a Receive (Rx) signal, wherein the Rx signal is based on a combination of the first RF signal and the second RF signal.

Example 17 includes the subject matter of Example 16, and, optionally, wherein the first RF path comprises a first Low Noise Amplifier (LNA) to amplify the first RF signal received via the first antenna port, and the second RF path comprises a second LNA to amplify the second RF signal received via the second antenna port.

Example 18 includes the subject matter of any one of Examples 1-17, and, optionally, wherein the first RF path is configured to communicate the first RF signal via a first antenna port of a dual-polarization antenna element, and the second RF path is configured to communicate the second RF signal via a second antenna port of the dual-polarization antenna element.

Example 19 includes the subject matter of any one of Examples 1-17, and, optionally, wherein the first RF path is configured to communicate the first RF signal via a first antenna port of a first antenna element, and the second RF path is configured to communicate the second RF signal via a second antenna port of a second antenna element.

Example 20 includes the subject matter of any one of Examples 1-19, and, optionally, wherein the polarization-control circuitry is configured to control the polarization for the communicated signal according to a plurality of polarization settings.

Example 21 includes the subject matter of any one of Examples 1-20, and, optionally, wherein the phase-offsetting circuitry is configurable to apply substantially any phase offset within a predefined range of phase offsets.

Example 22 includes the subject matter of any one of Examples 1-21, and, optionally, wherein the polarization-control circuitry is configured to control the polarization for the communicated signal according to substantially any polarization setting within a predefined range of polarizations.

Example 23 includes the subject matter of any one of Examples 1-22, and, optionally, wherein the polarization-control circuitry is configured to control the polarization for the communicated signal according to a linear polarization setting.

Example 24 includes the subject matter of any one of Examples 1-23, and, optionally, wherein the polarization-control circuitry is configured to control the polarization for the communicated signal according to substantially any linear polarization setting within a predefined range of linear polarizations.

Example 25 includes the subject matter of any one of Examples 1-24, and, optionally, wherein the polarization-control circuitry is configured to control the polarization for the communicated signal according to a selected linear polarization setting from a plurality of linear polarization settings comprising a Vertical (V) polarization setting, a Horizontal (H) polarization setting, and a 45 degrees linear polarization setting.

Example 26 includes the subject matter of any one of Examples 1-25, and, optionally, wherein the polarization-control circuitry is configured to control the polarization for the communicated signal according to a Circular Polarization (CP) setting.

Example 27 includes the subject matter of any one of Examples 1-26, and, optionally, wherein the polarization-control circuitry is configured to control the polarization for the communicated signal according to substantially any Circular Polarization (CP) setting within a predefined range of circular polarizations.

Example 28 includes the subject matter of any one of Examples 1-27, and, optionally, wherein the polarization-control circuitry is configured to control the polarization for the communicated signal according to a selected Circular Polarization (CP) setting from a plurality of circular polarization settings comprising a Clockwise (CW) CP setting and a Counter CW (CCW) CP setting.

Example 29 includes the subject matter of any one of Examples 1-28, and, optionally, wherein the polarization-control circuitry is configured to control the polarization for the communicated signal according to an elliptical polarization.

Example 30 includes the subject matter of any one of Examples 1-29, and, optionally, wherein the polarization-control circuitry is configured to control the polarization for the communicated signal according to substantially any elliptical polarization within a predefined range of elliptical polarizations.

Example 31 includes the subject matter of any one of Examples 1-30, and, optionally, wherein the first polarization is orthogonal to the second polarization.

Example 32 includes the subject matter of any one of Examples 1-31, and, optionally, wherein the first polarization comprises a Vertical (V) polarization, and the second polarization comprises a Horizontal (H) polarization.

Example 33 includes the subject matter of any one of Examples 1-32, and, optionally, comprising processing circuitry connected to the first RF path and to the second RF path, wherein the processing circuitry is configured to process the communicated signal based on the polarization setting.

Example 34 includes the subject matter of Example 33, and, optionally, wherein the processing circuitry comprises RF processing circuitry.

Example 35 includes the subject matter of Example 33, and, optionally, wherein the processing circuitry comprises a baseband processor.

Example 36 includes the subject matter of any one of Examples 1-35, comprising a radar processor configured to determine the polarization setting.

Example 37 includes the subject matter of Example 36, and, optionally, wherein the radar processor is configured to determine the polarization setting based on a steering angle of an antenna array to communicate the communicated signal.

Example 38 includes the subject matter of any one of Examples 1-37, and, optionally, comprising a dual-polarization antenna element comprising the first antenna port and the second antenna port.

Example 39 includes the subject matter of any one of Examples 1-37, and, optionally, comprising a first antenna element comprising the first antenna port, and a second antenna element comprising the second antenna port.

Example 40 includes the subject matter of any one of Examples 1-39, and, optionally, comprising a radar device, the radar device comprising a plurality of Transmit (Tx) antennas to transmit radar Tx signals, and a plurality of Rx antennas to receive radar receive (Rx) signals based on the radar Tx signals, wherein the communicated signal is a radar signal of the radar Tx signals or the radar Rx signals.

Example 41 includes the subject matter of Example 40, and, optionally, comprising a radar processor configured to generate radar information based on the Radar Rx signals.

Example 42 includes the subject matter of Example 41, and, optionally, comprising a vehicle, the vehicle comprising the radar device, and a system controller to control one or more systems of the vehicle based on the radar information.

Example 43 includes a polarization controller according to any of Examples 1-42.

Example 44 includes a device comprising a communication interface to communicate signals via one or more antennas, and a polarization controller to control a polarization for a communicated signal according to a polarization setting according to any of Examples 1-42.

Example 45 includes a radar device comprising a polarization controller according to any of Examples 1-42.

Example 46 includes a vehicle comprising a polarization controller according to any of Examples 1-42.

Example 47 comprises a product comprising one or more tangible computer-readable non-transitory storage media comprising computer-executable instructions operable to, when executed by at least one processor, enable the at least one processor to cause a device to perform any of the described operations of any of Examples 1-42.

Example 48 includes an apparatus comprising means for controlling a polarization for a communicated signal according to a polarization setting according to any of Examples 1-42.

Example 49 includes a method of controlling a polarization for a communicated signal according to any of Examples 1-42.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
polarization-control circuitry configured to control a polarization for a communicated signal according to a polarization setting, the polarization-control circuitry comprising:
a first Radio Frequency (RF) path configured to communicate a first RF signal corresponding to the communicated signal via a first antenna port according to a first polarization;
a second RF path configured to communicate a second RF signal corresponding to the communicated signal via a second antenna port according to a second polarization;
phase-offsetting circuitry comprising at least one phase shifter in at least one path of the first RF path or the second RF path, the phase-offsetting circuitry configurable to apply a phase offset between the first RF signal in the first RF path and the second RF signal in the second RF path; and
a controller configured to configure the phase-offsetting circuitry to apply the phase offset based on the polarization setting.

2. The apparatus of claim 1, wherein the polarization for the communicated signal is based on the first polarization, the second polarization, and the phase offset.

3. The apparatus of claim 1, wherein the polarization for the communicated signal is based on a combination of the first polarization and the second polarization according to the phase offset.

4. The apparatus of claim 1, wherein the controller is configured to configure the phase-offsetting circuitry to apply a first phase offset based on a first polarization setting, and to configure the phase-offsetting circuitry to apply a second phase offset based on a second polarization setting, wherein the first phase offset is different from the second phase offset, and the first polarization setting is different from the second polarization setting.

5. The apparatus of claim 1, wherein the phase-offsetting circuitry comprises a first-path phase shifter configurable to apply a first-path phase shift to the first RF signal in the first RF path, and a second-path phase shifter configurable to apply a second-path phase shift to the second RF signal in the second RF path, wherein the controller is configured to configure the first-path phase shifter to apply the first-path phase shift and the second-path phase shifter to apply the second-path phase shift based on the polarization setting.

6. The apparatus of claim 1, wherein the first RF path comprises a first amplifier to amplify the first RF signal, and the second RF path comprises a second amplifier to amplify the second RF signal.

7. The apparatus of claim 6, wherein at least one amplifier of the first amplifier or the second amplifier comprises an adjustable amplifier, wherein the controller is configured to configure the adjustable amplifier according to a gain difference to be applied between the first RF signal in the first RF path and the second RF signal in the second RF path, wherein the gain difference is based on the polarization setting.

8. The apparatus of claim 1, wherein the phase shifter is switchable between a plurality of predefined phase-shifter settings corresponding to a plurality of predefined phase shifts, wherein the controller is configured to set the phase-shifter to a selected phase-shifter setting from the plurality of predefined phase-shifter settings based on the polarization setting.

9. The apparatus of claim 8, wherein the phase shifter comprises a plurality of phase-shifter paths corresponding to the plurality of predefined phase-shifter settings, wherein the controller is configured to switch the phase shifter to a selected phase-shifter path of the plurality of phase-shifter paths based on the predefined phase-shift setting.

10. The apparatus of claim 1, wherein the communicated signal comprises a Transmit (Tx) signal, wherein the first RF signal and the second RF signal are based on a splitting of the Tx signal.

11. The apparatus of claim 10, wherein the first RF path comprises a first Power Amplifier (PA) to amplify the first RF signal to be transmitted via the first antenna port, and the second RF path comprises a second PA to amplify the second RF signal to be transmitted via the second antenna port.

12. The apparatus of claim 1, wherein the communicated signal comprises a Receive (Rx) signal, wherein the Rx signal is based on a combination of the first RF signal and the second RF signal.

13. The apparatus of claim 12, wherein the first RF path comprises a first Low Noise Amplifier (LNA) to amplify the first RF signal received via the first antenna port, and the second RF path comprises a second LNA to amplify the second RF signal received via the second antenna port.

14. The apparatus of claim 1, wherein the polarization-control circuitry is configured to control the polarization for the communicated signal according to a plurality of polarization settings.

15. The apparatus of claim 1, wherein the polarization-control circuitry is configured to control the polarization for the communicated signal according to substantially any polarization setting within a predefined range of polarizations.

16. The apparatus of claim 1, wherein the polarization-control circuitry is configured to control the polarization for the communicated signal according to a linear polarization setting.

17. The apparatus of claim 1, wherein the polarization-control circuitry is configured to control the polarization for the communicated signal according to a selected linear polarization setting from a plurality of linear polarization settings comprising a Vertical (V) polarization setting, a Horizontal (H) polarization setting, and a 45 degrees linear polarization setting.

18. The apparatus of claim 1, wherein the polarization-control circuitry is configured to control the polarization for the communicated signal according to a Circular Polarization (CP) setting.

19. The apparatus of claim 1, wherein the polarization-control circuitry is configured to control the polarization for the communicated signal according to a selected Circular Polarization (CP) setting from a plurality of circular polarization settings comprising a Clockwise (CW) CP setting and a Counter CW (CCW) CP setting.

20. The apparatus of claim 1, wherein the polarization-control circuitry is configured to control the polarization for the communicated signal according to an elliptical polarization.

21. The apparatus of claim 1 comprising processing circuitry connected to the first RF path and to the second RF path, wherein the processing circuitry is configured to process the communicated signal based on the polarization setting.

22. The apparatus of claim 1, comprising a radar processor configured to determine the polarization setting based on a steering angle of an antenna array to communicate the communicated signal.

23. The apparatus of claim 1 comprising a dual-polarization antenna element comprising the first antenna port and the second antenna port.

24. The apparatus of claim 1 comprising a first antenna element comprising the first antenna port, and a second antenna element comprising the second antenna port.

25. The apparatus of claim 1 comprising a radar device, the radar device comprising a plurality of Transmit (Tx) antennas to transmit radar Tx signals, a plurality of Rx antennas to receive radar receive (Rx) signals based on the radar Tx signals, and a radar processor configured to generate radar information based on the Radar Rx signals, wherein the communicated signal is a radar signal of the radar Tx signals or the radar Rx signals.

26. A vehicle comprising:
a system controller configured to control one or more vehicular systems of the vehicle based on radar information; and
a radar system configured to provide the radar information to the system controller, the radar system comprising:
one or more Transmit (Tx) antennas to transmit radar Tx signals;
one or more Receive (Rx) antennas to receive radar receive (Rx) signals based on the radar Tx signals;
polarization-control circuitry configured to control a polarization for a communicated signal according to a polarization setting, the communicated signal is a radar signal of the radar Tx signals or the radar Rx signals, the polarization-control circuitry comprising:
a first Radio Frequency (RF) path configured to communicate a first RF signal corresponding to the communicated signal via a first antenna port according to a first polarization;
a second RF path configured to communicate a second RF signal corresponding to the communicated signal via a second antenna port according to a second polarization;
phase-offsetting circuitry comprising at least one phase shifter in at least one path of the first RF path or the second RF path, the phase-offsetting circuitry configurable to apply a phase offset between the first RF signal in the first RF path and the second RF signal in the second RF path; and
a controller configured to configure the phase-offsetting circuitry to apply the phase offset based on the polarization setting; and
a radar processor configured to generate the radar information based on the radar Rx signals.

27. The vehicle of claim 26, wherein the radar processor is configured to determine the polarization setting based on a steering angle of an antenna array to communicate the communicated signal.
